(19) United States
(12) Patent Application Publication
(10) Pub. No.: US 2025/0358086 A1
(43) Pub. Date: Nov. 20, 2025

(54) TECHNIQUES FOR PARTIAL RESOURCE BLOCK (RB) BUNDLING AND SCALING

(71) Applicant: QUALCOMM Incorporated, San Diego, CA (US)

(72) Inventors: Muhammad Sayed Khairy ABDELGHAFFAR, San Jose, CA (US); Ahmed Attia ABOTABL, San Diego, CA (US); Prashant SHARMA, San Marcos, CA (US); Abdelrahman Mohamed IBRAHIM, San Diego, CA (US)

(21) Appl. No.: 19/205,431

(22) Filed: May 12, 2025

Related U.S. Application Data
(60) Provisional application No. 63/649,315, filed on May 17, 2024.

(51) Int. Cl. H04L 5/14; H04L 5/00; H04W 72/20

(52) U.S. Cl. CPC H04L 5/14; H04L 5/0053; H04W 72/20

(57) ABSTRACT

Methods, systems, and devices for wireless communications are described. In some cases, a user equipment (UE) may receive, via a sub-band full-duplex (SBFD) slot, a control message scheduling a first message associated with a first transmission direction, where the control message includes a resource indicator value indicating a starting virtual resource block group (RBG) and a set of contiguous virtual RBGs. Thus, the UE may map the set of contiguous virtual RBGs to a set of physical RBGs based on a determination of whether at least a portion of a first physical RBG is used for communication of the first message. In such cases, the determination may be based on the first physical RBG including one or more first physical resource blocks (PRBs) associated with the first transmission direction.

### CROSS REFERENCES

The present application for patent claims benefit of U.S. Provisional Patent Application No. 63/649,315 by ABDELGHAFFAR et al., entitled “TECHNIQUES FOR PARTIAL RESOURCE BLOCK (RB) BUNDLING AND SCALING,” filed May 17, 2024, assigned to the assignee hereof, and hereby expressly incorporated by reference herein in its entirety as if fully set forth below and for all applicable purposes.

### FIELD OF TECHNOLOGY

The following relates to wireless communications, including techniques for partial resource block (RB) bundling and scaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, via a sub-band full-duplex (SBFD) slot, a control message scheduling a first message associated with a first transmission direction, where the control message includes a non-interleaved resource indicator value (RIV) indicating a starting virtual resource block group (RBG) and a set of contiguous virtual RBGs, mapping the set of contiguous virtual RBGs to a set of physical RBGs based on a determination of whether at least a portion of a first physical RBG is used for communication of the first message, and where the determination is based on the first physical RBG including one or more first physical resource blocks (PRBs) associated with the first transmission direction, and communicating the first message based on the set of contiguous virtual RBGs being mapped to the set of physical RBGs.

A UE for wireless communications is described. The UE may include one or more memories storing processor executable code, and one or more processors coupled with the one or more memories. The one or more processors may individually or collectively be operable to execute the code to cause the UE to receive, via a SBFD slot, a control message scheduling a first message associated with a first transmission direction, where the control message includes a non-interleaved RIV indicating a starting virtual RBG and a set of contiguous virtual RBGs, map the set of contiguous virtual RBGs to a set of physical RBGs based on a determination of whether at least a portion of a first physical RBG is used for communication of the first message, and where the determination is based on the first physical RBG including one or more first PRBs associated with the first transmission direction, and communicate the first message based on the set of contiguous virtual RBGs being mapped to the set of physical RBGs.

Another UE for wireless communications is described. The UE may include means for receiving, via a SBFD slot, a control message scheduling a first message associated with a first transmission direction, where the control message includes a non-interleaved RIV indicating a starting virtual RBG and a set of contiguous virtual RBGs, means for mapping the set of contiguous virtual RBGs to a set of physical RBGs based on a determination of whether at least a portion of a first physical RBG is used for communication of the first message, and where the determination is based on the first physical RBG including one or more first PRBs associated with the first transmission direction, and means for communicating the first message based on the set of contiguous virtual RBGs being mapped to the set of physical RBGs.

A non-transitory computer-readable medium storing code for wireless communications is described. The code may include instructions executable by one or more processors to receive, via a SBFD slot, a control message scheduling a first message associated with a first transmission direction, where the control message includes a non-interleaved RIV indicating a starting virtual RBG and a set of contiguous virtual RBGs, map the set of contiguous virtual RBGs to a set of physical RBGs based on a determination of whether at least a portion of a first physical RBG is used for communication of the first message, and where the determination is based on the first physical RBG including one or more first PRBs associated with the first transmission direction, and communicate the first message based on the set of contiguous virtual RBGs being mapped to the set of physical RBGs.

In some examples of the method, UEs, and non-transitory computer-readable medium described herein, determining whether at least the portion of the first physical RBG may be used for communication of the first message may include operations, features, means, or instructions for determining that at least the portion of the first physical RBG may be used for communication based at least in part on at least the portion of the first physical RBG including the one or more first PRBs associated with the first transmission direction.

Some examples of the method, UEs, and non-transitory computer-readable medium described herein may further include operations, features, means, or instructions for calculating a transport block size (TBS) associated with the first message based on a quantity of PRBs, where the quantity of PRBs includes the one or more first PRBs and excludes the one or more second PRBs.

Some examples of the method, UEs, and non-transitory computer-readable medium described herein may further include operations, features, means, or instructions for calculating a TBS associated with the first message based on a quantity of PRBs, where the quantity of PRBs includes both the one or more first PRBs and one or more second PRBs (e.g., associated with at least one of a second transmission direction or a guard-band).

In some examples of the method, UEs, and non-transitory computer-readable medium described herein, determining whether at least the portion of the first physical RBG may be used for communication of the first message may include operations, features, means, or instructions for determining the first physical RBG may be not used for communication based on the first physical RBG including the one or more second PRBs associated with the at least one of the second transmission direction or the guard-band.

Some examples of the method, UEs, and non-transitory computer-readable medium described herein may further include operations, features, means, or instructions for calculating a TBS associated with the first message based on a quantity of PRBs, where the quantity of PRBs excludes both the one or more first PRBs the one or more second PRBs of the first physical RBG.

In some examples of the method, UEs, and non-transitory computer-readable medium described herein, the SBFD slot includes both a first sub-band and a second sub-band associated with the first transmission direction, a size of a last physical RBG of a first subset of the set of physical RBGs may be based on a starting RB associated with the SBFD slot, a quantity of RBs associated with the first subset of the set of physical RBGs, a size of each physical RBG of the set of physical RBGs, or any combination thereof, and the first subset may be associated with the first sub-band.

In some examples of the method, UEs, and non-transitory computer-readable medium described herein, the SBFD slot includes both a first sub-band and a second sub-band associated with the first transmission direction, a size of a starting physical RBG of a second subset of the set of physical RBGs may be based on a size of each physical RBG of the set of physical RBGs, a first RB associated with the second sub-band, or both, and the second subset may be associated with the second sub-band.

In some examples of the method, UEs, and non-transitory computer-readable medium described herein, the control message may be associated with a downlink control information (DCI) format 1_2 or a DCI format 0_2.

A method for wireless communications by a UE is described. The method may include receiving, via a SBFD slot, a control message scheduling a downlink message, where the control message includes an interleaved RIV indicating a starting virtual resource block (VRB) bundle and a set of VRB bundles, mapping the set of VRB bundles to a set of PRB bundles based on a determination of whether at least a portion of a first PRB bundle is used for communication of the downlink message, where the determination is based on the first PRB bundle including one or more downlink PRBs and one or more uplink PRBs, and receiving the downlink message based on the set of VRB bundles being mapped to the set of PRB bundles.

A UE for wireless communications is described. The UE may include one or more memories storing processor executable code, and one or more processors coupled with the one or more memories. The one or more processors may individually or collectively be operable to execute the code to cause the UE to receive, via a SBFD slot, a control message scheduling a downlink message, where the control message includes an interleaved RIV indicating a starting VRB bundle and a set of VRB bundles, map the set of VRB bundles to a set of PRB bundles based on a determination of whether at least a portion of a first PRB bundle is used for communication of the downlink message, where the determination is based on the first PRB bundle including one or more downlink PRBs and one or more uplink PRBs, and receive the downlink message based on the set of VRB bundles being mapped to the set of PRB bundles.

Another UE for wireless communications is described. The UE may include means for receiving, via a SBFD slot, a control message scheduling a downlink message, where the control message includes an interleaved RIV indicating a starting VRB bundle and a set of VRB bundles, means for mapping the set of VRB bundles to a set of PRB bundles based on a determination of whether at least a portion of a first PRB bundle is used for communication of the downlink message, where the determination is based on the first PRB bundle including one or more downlink PRBs and one or more uplink PRBs, and means for receiving the downlink message based on the set of VRB bundles being mapped to the set of PRB bundles.

A non-transitory computer-readable medium storing code for wireless communications is described. The code may include instructions executable by one or more processors to receive, via a SBFD slot, a control message scheduling a downlink message, where the control message includes an interleaved RIV indicating a starting VRB bundle and a set of VRB bundles, map the set of VRB bundles to a set of PRB bundles based on a determination of whether at least a portion of a first PRB bundle is used for communication of the downlink message, where the determination is based on the first PRB bundle including one or more downlink PRBs and one or more uplink PRBs, and receive the downlink message based on the set of VRB bundles being mapped to the set of PRB bundles.

In some examples of the method, UEs, and non-transitory computer-readable medium described herein, determining whether at least the portion of the first PRB bundle may be used for communication of the downlink message may include operations, features, means, or instructions for determining that at least the portion of the first PRB bundle may be used for communication based at least in part on at least the portion of the first PRB bundle including the one or more downlink PRBs.

Some examples of the method, UEs, and non-transitory computer-readable medium described herein may further include operations, features, means, or instructions for calculating a TBS associated with the downlink message based on a quantity of PRBs, where the quantity of PRBs includes the one or more downlink PRBs and excludes the one or more uplink PRBs.

Some examples of the method, UEs, and non-transitory computer-readable medium described herein may further include operations, features, means, or instructions for calculating a TBS associated with the downlink message based on a quantity of PRBs, where the quantity of PRBs includes both the one or more downlink PRBs and the one or more uplink PRBs.

In some examples of the method, UEs, and non-transitory computer-readable medium described herein, determining whether at least the portion of the first PRB bundle may be used for communication of the downlink message may include operations, features, means, or instructions for determining the first PRB bundle may be not used for communication based on the first PRB bundle including the one or more uplink PRBs.

Some examples of the method, UEs, and non-transitory computer-readable medium described herein may further include operations, features, means, or instructions for calculating a TBS associated with the downlink message based on a quantity of PRBs, where the quantity of PRBs excludes both the one or more downlink PRBs the one or more uplink PRBs of the first PRB bundle.

In some examples of the method, UEs, and non-transitory computer-readable medium described herein, the SBFD slot includes both a first downlink sub-band and a second downlink sub-band associated, a size of a last PRB bundle of a first subset of the set of PRB bundles may be based on a starting RB associated with the SBFD slot, a quantity of RBs associated with the first subset of the set of PRB bundles, a size of each PRB bundle of the set of PRB bundles, or any combination thereof, and the first subset may be associated with the first downlink sub-band.

In some examples of the method, UEs, and non-transitory computer-readable medium described herein, the SBFD slot includes both a first downlink sub-band and a second downlink sub-band, a size of a starting PRB bundle of a second subset of the set of PRB bundles may be based on a size of each PRB bundle of the set of PRB bundles available for communication of the downlink message, a first RB associated with the second downlink sub-band, or both, and the second subset may be associated with the second downlink sub-band.

A method for wireless communications by a UE is described. The method may include receiving, via a SBFD slot, a control message scheduling a first message, where the control message includes a RIV indicating a first starting RB and a set of contiguous RBs, determining a second starting RB of a resource allocation and a length of the resource allocation based on an integer value, where the integer value is based on a first quantity of RBs of the resource allocation, a size of an active BWP, a predefined value, or any combination thereof, wherein the first quantity of RBs is associated with a first transmission direction, and communicating the first message in accordance with the resource allocation.

A UE for wireless communications is described. The UE may include one or more memories storing processor executable code, and one or more processors coupled with the one or more memories. The one or more processors may individually or collectively be operable to execute the code to cause the UE to receive, via a SBFD slot, a control message scheduling a first message, where the control message includes a RIV indicating a first starting RB and a set of contiguous RBs, determine a second starting RB of a resource allocation and a length of the resource allocation based on an integer value, where the integer value is based on a first quantity of RBs of the resource allocation, a size of an active BWP, a predefined value, or any combination thereof, wherein the first quantity of RBs is associated with a first transmission direction, and communicate the first message in accordance with the resource allocation.

Another UE for wireless communications is described. The UE may include means for receiving, via a SBFD slot, a control message scheduling a first message, where the control message includes a RIV indicating a first starting RB and a set of contiguous RBs, means for determining a second starting RB of a resource allocation and a length of the resource allocation based on an integer value, where the integer value is based on a first quantity of RBs of the resource allocation, a size of an active BWP, a predefined value, or any combination thereof, wherein the first quantity of RBs is associated with a first transmission direction, and means for communicating the first message in accordance with the resource allocation.

A non-transitory computer-readable medium storing code for wireless communications is described. The code may include instructions executable by one or more processors to receive, via a SBFD slot, a control message scheduling a first message, where the control message includes a RIV indicating a first starting RB and a set of contiguous RBs, determine a second starting RB of a resource allocation and a length of the resource allocation based on an integer value, where the integer value is based on a first quantity of RBs of the resource allocation, a size of an active BWP, a predefined value, or any combination thereof, wherein the first quantity of RBs is associated with a first transmission direction, and communicate the first message in accordance with the resource allocation.

In some examples of the method, UEs, and non-transitory computer-readable medium described herein, the first quantity of RBs associated with the first transmission direction may be greater than a second quantity of RBs associated with an initial BWP and the integer value may be equal to a threshold value of {1, 2, 4, 8} that satisfies the integer value being less than or equal to a floor of the first quantity of RBs associated with the first transmission direction divided by the second quantity of RBs associated with the initial BWP.

In some examples of the method, UEs, and non-transitory computer-readable medium described herein, the first quantity of RBs associated with the first transmission direction may be less than or equal to a second quantity of RBs associated with an initial BWP and the integer value may be equal to 1.

In some examples of the method, UEs, and non-transitory computer-readable medium described herein, both the second starting RB and the length of the resource allocation may be within the first quantity of RBs associated with the first transmission direction.

In some examples of the method, UEs, and non-transitory computer-readable medium described herein, the second starting RB may be equal to an offset added to the integer value times the first starting RB.

Some examples of the method, UEs, and non-transitory computer-readable medium described herein may further include operations, features, means, or instructions for receiving a second control message indicating the offset.

In some examples of the method, UEs, and non-transitory computer-readable medium described herein, the second control message may be a radio resource control (RRC) message or a DCI message.

Some examples of the method, UEs, and non-transitory computer-readable medium described herein may further include operations, features, means, or instructions for determining the offset based on a first RB in a sub-band, where the sub-band may be associated with the first transmission direction.

In some examples of the method, UEs, and non-transitory computer-readable medium described herein, the second starting RB may be relative to a first RB in a sub-band and the sub-band may be associated with the first transmission direction.

In some examples of the method, UEs, and non-transitory computer-readable medium described herein, the predefined value may be equal to 1, 2, 3, 4, 5, 6, 7, or 8.

In some examples of the method, UEs, and non-transitory computer-readable medium described herein, the control message may be associated with a DCI format 0_0 or a DCI format 1_0.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for partial resource block (RB) bundling and scaling in accordance with one or more aspects of the present disclosure.

FIGS. 2A, 2B, and 2C show examples of resource allocation schemes that support techniques for partial RB bundling and scaling in accordance with one or more aspects of the present disclosure.

FIG. 3 shows examples of resource allocation schemes that support techniques for partial RB bundling and scaling in accordance with one or more aspects of the present disclosure.

FIG. 4 shows examples of resource allocation schemes that support techniques for partial RB bundling and scaling in accordance with one or more aspects of the present disclosure.

FIGS. 5A, 5B, and 5C show examples of resource allocations that support techniques for partial RB bundling and scaling in accordance with one or more aspects of the present disclosure.

FIG. 6 shows an example of a process flow that supports techniques for partial RB bundling and scaling in accordance with one or more aspects of the present disclosure.

FIG. 7 shows an example of a process flow that supports techniques for partial RB bundling and scaling in accordance with one or more aspects of the present disclosure.

FIG. 8 shows an example of a process flow that supports techniques for partial RB bundling and scaling in accordance with one or more aspects of the present disclosure.

FIGS. 9 and 10 show block diagrams of devices that support techniques for partial RB bundling and scaling in accordance with one or more aspects of the present disclosure.

FIG. 11 shows a block diagram of a communications manager that supports techniques for partial RB bundling and scaling in accordance with one or more aspects of the present disclosure.

FIG. 12 shows a diagram of a system including a device that supports techniques for partial RB bundling and scaling in accordance with one or more aspects of the present disclosure.

FIGS. 13 through 15 show flowcharts illustrating methods that support techniques for partial RB bundling and scaling in accordance with one or more aspects of the present disclosure.

### DETAILED DESCRIPTION

In some wireless communications systems, a network entity may indicate, to a user equipment (UE), a resource allocation for a scheduled message (e.g., a physical downlink shared channel (PDSCH) message, or a physical uplink shared channel (PUSCH) message) via a resource indicator value (RIV) in a control message (e.g., a downlink control information (DCI) message). In some cases (e.g., DCI format 1_1 or 0_1), the RIV may indicate a starting virtual resource block (VRB) and a set of contiguous VRBs (e.g., a length of VRBs). In some other cases (e.g., DCI format 1_2 or 0_2), the RIV may indicate a starting virtual resource block group (RBG) (e.g., an RBG including VRBs) and a set of contiguous virtual RBGs (e.g., a length of virtual RBGs). In such cases, the UE may map the set of contiguous virtual RBGs to a set of physical RBGs (e.g., RBGs including physical resource blocks (PRBs)). However, in some cases, the set of physical RBGs may be associated with a set of sub-band full-duplex (SBFD) symbols in a slot, such that some PRBs of the physical RBGs may be associated with a first transmission direction (e.g., uplink or downlink) opposite a second transmission direction (e.g., downlink or uplink) associated with the scheduled message. Thus, when interleaving is not enabled, the UE may attempt to map a virtual RBG to a physical RBG, where the physical RBG, which may be referred to as a partial physical RBG, includes one or more first PRBs associated with the first transmission direction and one or more second PRBs associated with the second transmission direction. In such cases, the UE may be unable to determine whether the partial physical RBG is valid (e.g., may be used for communication of the scheduled message).

In some other cases (e.g., for other PDSCH transmissions not scheduled by DCI format 1_1, 0_1, 1_2, or 0_2), the network entity may indicate, to the UE, a resource allocation for a downlink message via an RIV, where the RIV indicates a starting VRB and a set of contiguous VRBs (e.g., length of VRBs) grouped into VRB bundles. Thus, the UE may map the VRB bundles to PRB bundles. However, as described previously with reference to the physical RBGs, in some cases, the PRB bundles may be associated with a set of SBFD symbols in a slot, such that some PRBs of the PRB bundles may be uplink PRBs. Thus, when VRB-to-PRB interleaving is enabled, the UE may attempt to map a VRB bundle to PRB bundle, where the PRB bundle, which may be referred to as a partial PRB bundle, includes one or more PRBs in an uplink sub-band, one or more PRBs in a guard-band, or both. In such cases, the UE may be unable to determine whether the partial PRB bundle is valid (e.g., may be used for communication of the downlink message).

Additionally, or alternatively, the UE may determine a resource allocation (e.g., set of VRBs, set of virtual RBGs, set of VRB bundles) for an active bandwidth part (BWP) associated with the UE based on an indicated RIV and an integer value, K. That is, the UE may determine a first starting resource block (RB) of the resource allocation based on a product of the integer and a second starting RB indicated via the RIV. Similarly, the UE may determine a size (e.g., length) of the resource allocation based on a product of the integer and a length of RBs indicated via the RIV. However, in some cases, the UE may support SBFD symbols such that the active BWP may include one or more uplink PRBs and one or more downlink PRBs. In such cases, the UE may be unable to determine how to interpret the RIV.

Accordingly, techniques described herein may enable a UE to determine whether a partial physical RBG or a partial PRB bundle is valid. For example, in some cases, the UE may determine that the partial physical RBG or the partial PRB bundle is not valid based on the partial physical RBG or the partial PRB bundle including one or more first PRBs associated with a different transmission direction than that of a scheduled message, associated with a guard-band, or both. In some other cases, the UE may determine that the partial physical RBG or the partial PRB bundle is valid based on the partial physical RBG or the partial PRB bundle including one or more second PRBs associated with a same transmission direction as the scheduled message. That is, the UE may determine that the one or more second PRBs (e.g., associated with the same transmission direction) may be used for communication of the scheduled message and the one or more first PRBs (e.g., associated with the different transmission direction) may not be used for communication of the scheduled message.

Additionally, techniques described herein may enable the UE to interpret a RIV indicating a resource allocation for a scheduled message associated with one or more SBFD symbols. For example, in some cases, the UE may interpret the RIV relative to a set of PRBs associated with a same transmission direction as the scheduled message, which may be referred to as usable PRBs. In such cases, the integer value may be determined based on a size (e.g., quantity) of the usable PRBs. That is, in some cases, the integer value may be based on a size of the usable PRBs divided by a size of an initial BWP (e.g., a quantity of PRBs in the initial BWP). In another example, the UE may interpret the RIV relative to a size of an active BWP (e.g., quantity of PRBs in the active BWP). That is, a starting RB associated with the resource allocation may be based on the integer value, a starting RB indicated via the RIV, and an RB offset. In some other examples, the integer value may be a predefined value, such as a value between 1 and 8, such that the UE may interpret the RIV relative to the active BWP.

Aspects of the disclosure are initially described in the context of wireless communications systems. Aspects of the disclosure are then described in the process of resource allocation schemes, resource allocations, and process flows. Aspects of the disclosure are further illustrated by and described with reference to apparatus diagrams, system diagrams, and flowcharts that relate to techniques for partial RB bundling and scaling.

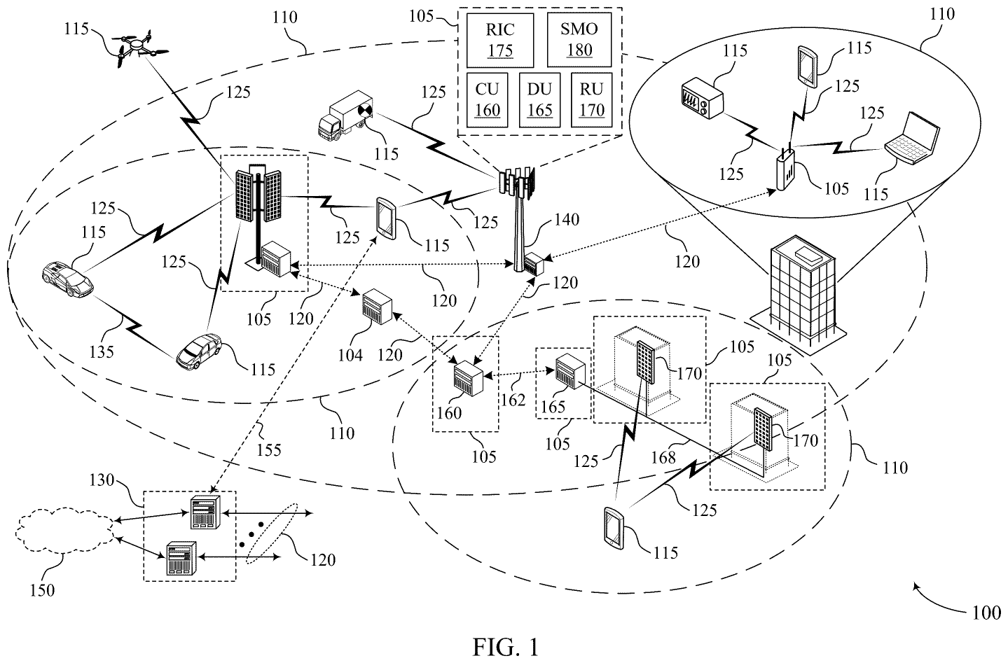

FIG. 1 shows an example of a wireless communications system 100 that supports techniques for partial RB bundling and scaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, a UE 115 of the wireless communications system 100 may determine whether a partial physical RBG or a partial PRB bundle is valid. For example, in some cases, the UE 115 may determine that the partial physical RBG or the partial PRB bundle is not valid based on the partial physical RBG or the partial PRB bundle including one or more first PRBs associated with a different transmission direction than that of a scheduled message, associated with a guard-band, or both. In some other cases, the UE 115 may determine that the partial physical RBG or the partial PRB bundle is valid based on the partial physical RBG or the partial PRB bundle including one or more second PRBs associated with a same transmission direction as the scheduled message. That is, the UE 115 may determine that the one or more second PRBs (e.g., associated with the same transmission direction) may be used for communication of the scheduled message and the one or more first PRBs (e.g., associated with the different transmission direction) may not be used for communication of the scheduled message.

Additionally, the UE 115 of the wireless communications system 100 may interpret a RIV indicating a resource allocation for a scheduled message associated with one or more SBFD symbols. For example, the in some cases, the UE 115 may interpret the RIV relative to a set of PRBs associated with a same transmission direction as the scheduled message, which may be referred to as usable PRBs. In such cases, the integer value may be determined based on a size (e.g., quantity) of the usable PRBs. That is, in some cases, the integer value may be based on a size of the usable PRBs divided by a size of an initial BWP (e.g., quantity of PRBs in the initial BWP). In another example, the UE 115 may interpret the RIV relative to a size of an active BWP (e.g., quantity of PRBs in the active BWP). That is, a starting RB associated with the resource allocation may be based on the integer value, a starting RB indicated via the RIV, and an RB offset. In some other examples, the integer value may be a predefined value, such as a value between 1 and 8, such that the UE 115 may interpret the RIV relative to the active BWP.

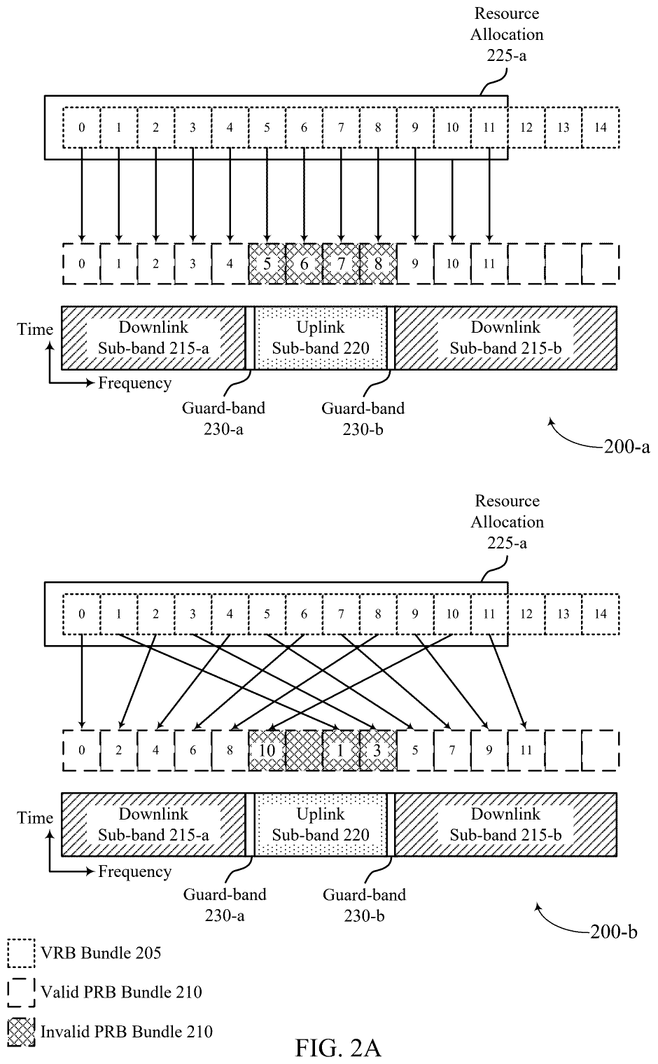

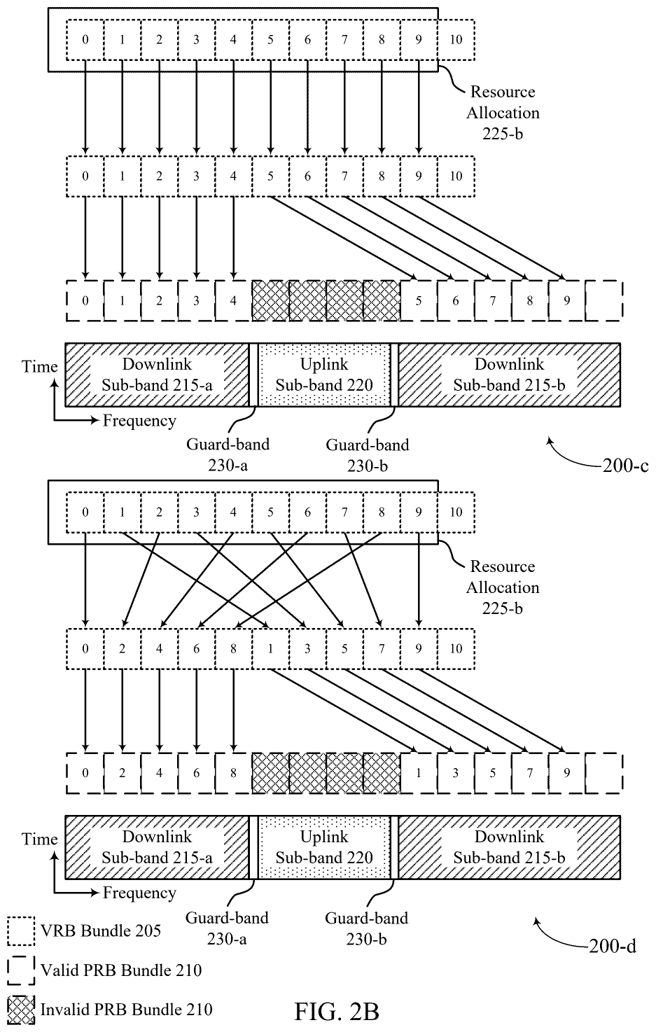

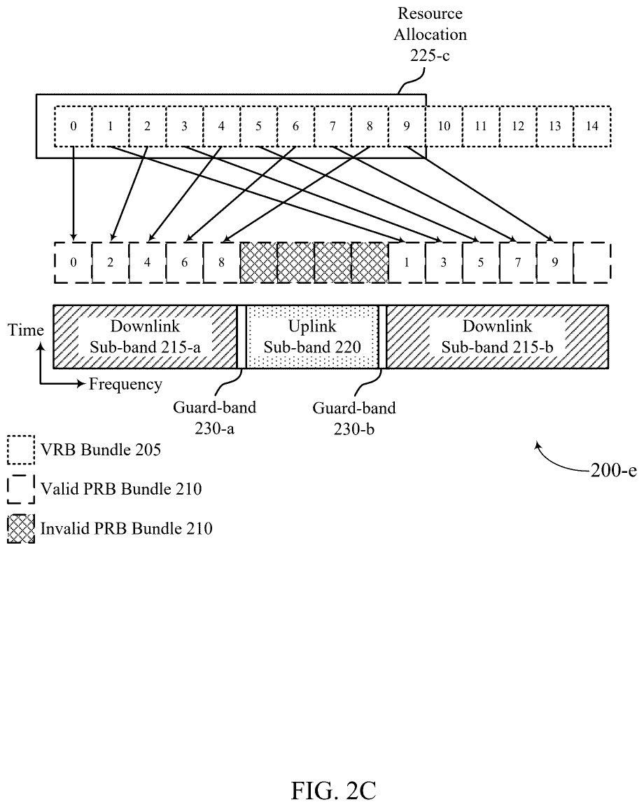

FIGS. 2A, 2B, and 2C show examples of resource allocation schemes 200 (e.g., a resource allocation scheme 200-a, a resource allocation scheme 200-b, a resource allocation scheme 200-c, a resource allocation scheme 200-d, and a resource allocation scheme 200-e) that support techniques for partial RB bundling and scaling in accordance with one or more aspects of the present disclosure. In some cases, the resource allocation schemes 200 may implement or be implemented by aspects of the wireless communications system 100. For example, the resource allocation schemes 200 may be implemented by one or more UEs 115 and one or more network entities 105, which may be examples of the corresponding devices as described herein

In some wireless communications systems, a network entity 105 may indicate, to a UE 115, a resource allocation for a scheduled message (e.g., PDSCH or PUSCH, respectively) via a control message (e.g., DCI). In some cases, the control message (e.g., DCI format 1_1 or 0_1) may include an RIV indicating the resource allocation (e.g., Type 1 resource allocation, RIV-based), where the RIV is associated with an RB-level granularity. That is, the RIV may indicate a starting VRB (e.g., RB start) and a set of contiguous VRBs (e.g., indicated via a length of VRBs, L_{RBs}) within an active BWP supported by the UE 115, where the set of contiguous VRBs may be interleaved or non-interleaved. For example, if

$$( {L}_{RBs} - 1 ) \leq ⌊ \frac{{N}_{BWP}^{size}}{2} ⌋ ,$$

then

$$RIV = {N}_{BWP}^{size} ( {L}_{RBs} - 1 ) + {RB}_{start} ,$$

where

$${N}_{BWP}^{size}$$

may represent a size of the active BWP (e.g., quantity of RBs in the active BWP). Otherwise,

$$RIV = {N}_{BWP}^{size} ( {N}_{BWP}^{size} - {L}_{RBs} - 1 ) + ( {N}_{BWP}^{size} - 1 - {RB}_{start} ) ,$$

where L_{RBS}≥1 and does not exceed

$${N}_{BWP}^{size} - {RB}_{start} .$$

In some other cases, the control message (e.g., DCI format 1_2 or 0_2) may include a bitmap indicating the resource allocation (e.g., Type 0 resource allocation) or may include an RIV indicating the resource allocation (e.g., Type 1 resource allocation, RIV-based), where the RIV is associated with an RBG-level granularity. That is, the RIV may indicate a starting virtual RBG (e.g., RBGₛₜₐᵣₜ) and a set of contiguous virtual RBGs (e.g., indicated via a length of virtual RBGs, L_{RBGs}) within the active BWP supported by the UE 115, where the set of contiguous virtual RBGs may be interleaved or non-interleaved. Additionally, a block size, P, (e.g., virtual RBG block size) may be 2, 4, 8, or 16 VRBs, where a first and last virtual RBG of the resource allocation may be partial virtual RBGs. For example, if

$$( {L}_{RBGs} - 1 ) \leq ⌊ \frac{{N}_{RBG}}{2} ⌋$$

then RIV=N_{RBG}(L_{RBGs}−1)+RBGₛₜₐᵣₜ, where N_{RBG} may represent a total quantity of RBGs for a downlink bandwidth part, i, of size

$${N}_{BWP , i}^{size} .$$

Otherwise, RIV=N_{RBG}(N_{RBG}−L_{RBGs}−1)+(N_{RBG}−1−RBGₛₜₐᵣₜ), where L_{RBgs}≥1 and does not exceed N_{RBG}−RBGₛₜₐᵣₜ. In such cases, N_{RBG} may be calculated according to the following Equation 1:

$${N}_{RBG} = ⌈ {N}_{BWP , i}^{size} + ( {N}_{BWP , i}^{start} mod P ) / P ⌉ \qquad ( 1 )$$

where

$${N}_{BWP , i}^{start}$$

may represent a starting position (e.g., first RB) of the downlink bandwidth part, i, where a size of a first RBG,

$${RBG}_{0}^{size} ,$$

may be calculated according to

$${RBG}_{0}^{size} = P - {N}_{BWP , i}^{start} mod P ,$$

where a size of a last RBG,

$${RBG}_{last}^{size} ,$$

may be calculated according to

$${RBG}_{last}^{size} = ( {N}_{BWP , i}^{start} + {N}_{BWP , i}^{size} ) mod P if ( {N}_{BWP , i}^{start} + {N}_{BWP , i}^{size} ) mod P > 0 ,$$

otherwise

$${RBG}_{last}^{size} = P ,$$

and where a size of all other RBGs is equal to P. In some examples, PUSCH Type 1 resource allocations may be (e.g., are always) non-interleaved.

In some other cases (e.g., for all other PDSCH transmissions), a set of

$${N}_{BWP , i}^{size}$$

RBs in the bandwidth part, i, with starting position

$${N}_{BWP , i}^{start}$$

may be divided into a quantity of RB-bundles, N_{bundle}, where

$${N}_{bundle} = ⌈ ( {N}_{BWP , i}^{size} + ( {N}_{BWP , i}^{start} mod {L}_{i} ) ) / {L}_{i} ⌉ ,$$

in increasing order of a RB number and bundle number, where Lᵢ is a bundle size for the bandwidth part, i. In some examples, the network entity 105 may transmit a control message (e.g., DCI) indicating Lᵢ. For example, the network entity 105 may transmit, in a UE-specific search space (USS), a DCI, associated with a DCI format 1_0 or a DCI format 1_1, indicating Lᵢ via a higher-layer (e.g., radio resource control RRC) parameter vrb-ToPRB-Interleaver. In another example, the network entity 105 may transmit a DCI, associated with a DCI format 1_2, indicating Lᵢ via a higher-layer parameter vrb-ToPRB-InterleaverDCI-1-2. In such cases, a first RB bundle (e.g., RB bundle 0) may include

$${L}_{i} - ( {N}_{B WP , i}^{start} mod {L}_{i} )$$

RBs and a last RB bundle (e.g., RB bundle N_{bundle}−1) may include

$$( {N}_{B WP , i}^{start} + {N}_{B W P , i}^{s i z e} ) mod {L}_{i}$$

### RBs if

$$( {N}_{B WP , i}^{start} + {N}_{BWP , i}^{s i z e} ) mod {L}_{i} > 0 ,$$

otherwise the last RB bundle may include Lᵢ RBs. Additionally, all other RB bundles may include Lᵢ RBs.

Thus, VRBs in an interval j∈{0,1, . . . , N_{bundle}−1} may be mapped to PRBs according to the VRB bundle N_{bundle}−1 being mapped to a PRB bundle N_{bundle}−1 and the VRB bundle j∈{0,1, . . . , N_{bundle}−1} being mapped to a PRB bundle f(j), where f(j)=rC+c, j=cR+r, r=0,1, . . . , R−1, c=0,1, . . . . C−1, R=2, and C=[N_{bundle}/R]. For example, for

$${N}_{B W P}^{start} = 1 , {N}_{B W P}^{s i z e} = 4 ,$$

and L=4, then N_{bundle}=[(59+(1 mod 4))/4]=15, a size of RB bundles #0=4−(1 mod 4)=3, and a size of RB bundle #14=4.

In some cases (e.g., Option 1), as depicted in FIG. 2A, for frequency domain Type 1 resource allocation for PDSCH in a single slot scheduled by a DCI format in a USS, assigned PRBs within downlink usable PRBs may be considered valid for PDSCH and assigned PRBs that fall outside of the downlink usable PRBs may not be considered valid and may not be used for PDSCH resource mapping. In such cases, the UE 115 may support a first RB indexing scheme and a first VRB-to-PRB mapping scheme. In some cases (e.g., Option 1-1), a quantity of PRBs used for transport block size (TBS) determination may be based on the assigned PRBs within the downlink usable PRBs. In some other cases (e.g., Option 1-2), the quantity of PRBs used for TBS determination may be based on the assigned PRBs (e.g., as legacy).

For example, the UE 115 may receive a resource allocation 225-a associated with a set of VRB bundles 205 (e.g., including VRBs). In such cases, the set of VRB bundles 205 may include VRB bundle #0 through VRB bundle #11. Additionally, the UE 115 may support a set of SBFD symbols in a slot, where each SBFD symbol includes a downlink sub-band 215-a, a guard band 230-a, an uplink sub-band 220, a guard band 230-b, and a downlink sub-band 215-b. As such, a first set of PRB bundles 210, associated with the downlink sub-band 215-a and the downlink sub-band 215-b, may include usable PRBs and may be referred to as valid PRB bundles 210. Conversely, a second set of PRB bundles 210 associated with the uplink sub-band 220 and associated with the guard bands 230 may include unusable PRBs and may be referred to as invalid PRB bundles 210 (e.g., a first subset of the second set of PRB bundles 210 may be associated with the uplink sub-band 220, a second subset of the second set of PRB bundles 210 may be associated with the guard band 230-a, and a third subset of the second set of PRB bundles 210 may be associated with the guard band 230-b).

Thus, when the UE 115 does not perform VRB-to-PRB interleaving, as depicted according to the resource allocation scheme 200-a, the UE 115 may refrain from mapping VRB bundle #5, VRB bundle #6, VRB bundle #7, and VRB bundle #8 to the second set of PRB bundles 210 based on the second set of PRB bundles 210 being invalid PRB bundles 210. In such cases, the quantity of PRBs used for TBS determination may be equal to 44 PRBs (e.g., for Option 1-2) or 32 PRBs (e.g., for Option 1-1). Similarly, when performing VRB-to-PRB interleaving, as depicted according to the resource allocation scheme 200-b, the UE 115 may refrain from mapping VRB bundle #10, VRB bundle #1, and VRB bundle #3 to the second set of PRB bundles 210 based on the second set of PRB bundles 210 being invalid PRB bundles 210. In such cases, the quantity of PRBs used for TBS determination may be equal to 44 PRBs (e.g., for Option 1-2) or 36 PRBs (e.g., for Option 1-1).

Additionally, or alternatively, as depicted in FIG. 2B (e.g., Option 2), the UE 115 may support a second (e.g., new) RB indexing scheme and a second (e.g., new) PRB bundle indexing scheme to enable VRBs to be mapped to downlink usable PRBs (e.g., only). In such cases, the UE 115 may support the first VRB-to-PRB mapping scheme and may support TBS determination (e.g., according to legacy procedures). For example, the UE 115 may receive a resource allocation 225-b associated with a set of VRB bundles 205. In such cases, the set of VRB bundles 205 may include VRB bundle #0 through VRB bundle #9. Additionally, the UE 115 may support the set of SBFD symbols in the slot, where each SBFD symbol includes the downlink sub-band 215-a, the guard band 230-a, the uplink sub-band 220, the guard band 230-b, and the downlink sub-band 215. As such, a first set of PRB bundles 210, associated with the downlink sub-band 215-a and the downlink sub-band 215-b, may include usable PRBs and may be referred to as valid PRB bundles 210. Conversely, a second set of PRB bundles 210 associated with the uplink sub-band 220 and associated with the guard bands 230 may include unusable PRBs and may be referred to as invalid PRB bundles 210 (e.g., a first subset of the second set of PRB bundles 210 may be associated with the uplink sub-band 220, a second subset of the second set of PRB bundles 210 may be associated with the guard band 230-a, and a third subset of the second set of PRB bundles 210 may be associated with the guard band 230-b).

Thus, when the UE 115 does not perform VRB-to-PRB interleaving, as depicted according to the resource allocation scheme 200-c, and when the UE 115 performs VRB-to-PRB interleaving, as depicted according to the resource allocation scheme 200-d, the UE 115 may avoid mapping to the invalid PRB bundles 210 based on the second RB indexing scheme and the second PRB bundle indexing scheme. In other words, the UE 115 may map the VRB bundles 205 to the valid PRB bundles 210 associated with the downlink sub-bands 215 and may avoid mapping the VRB bundles 205 to the invalid PRB bundles 210 associated with the uplink sub-band 220.

Additionally, or alternatively, as depicted in FIG. 2C (e.g., Option 3), the UE 115 may support a modified VRB-to-PRB interleaver that supports a second VRB-to-PRB mapping scheme (e.g., a modified version of the first VRB-to-PRB mapping scheme) to enable VRBs to be mapped to downlink usable PRBs (e.g., only). In such cases, the UE 115 may support TBS determination (e.g., according to legacy procedures). Additionally, if interleaving is not enabled for the UE 115, the UE 115 may map PRBs to VRBs according to the resource allocation 500-a (e.g., Option 1-1) or the resource allocation 500-b (e.g., Option 1-2).

For example, as depicted according to the resource allocation scheme 200-e, the UE 115 may receive a resource allocation 225-c associated with a set of VRB bundles 205. In such cases, the set of VRB bundles 205 may include VRB bundle #0 through VRB bundle #9. Additionally, the UE 115 may support the set of SBFD symbols in the slot, where each SBFD symbol includes the downlink sub-band 215-a, the guard band 230-a, the uplink sub-band 220, the guard band 230-b, and the downlink sub-band 215-b. As such, a first set of PRB bundles 210, associated with the downlink sub-band 215-a and the downlink sub-band 215-b, may include usable PRBs and may be referred to as valid PRB bundles 210. Conversely, a second set of PRB bundles 210 associated with the uplink sub-band 220 and associated with the guard bands 230 may include unusable PRBs and may be referred to as invalid PRB bundles 210 (e.g., a first subset of the second set of PRB bundles 210 may be associated with the uplink sub-band 220, a second subset of the second set of PRB bundles 210 may be associated with the guard band 230-a, and a third subset of the second set of PRB bundles 210 may be associated with the guard band 230-b). Thus, the UE 115 (e.g., with interleaving enabled) may avoid mapping to the invalid PRB bundles 210 using the modified VRB-to-PRB interleaver. In other words, the UE 115 may map the VRB bundles 205 to the valid PRB bundles 210 associated with the downlink sub-bands 215 and may avoid mapping the VRB bundles 205 to the invalid PRB bundles 210 associated with the uplink sub-band 220.

However, in some cases, the network entity 105 may transmit a first control message (e.g., DCI format 1_2 or 0_2) scheduling a message (e.g., PDSCH or PUSCH) in a set of SBFD symbols in a slot, where the first control message indicates a non-interleaved (e.g., interleaving is disabled) RIV of RBG-level granularity further indicating a resource allocation (e.g., Type 1 resource allocation). Thus, the UE 115 may attempt to map a set of virtual RBGs (e.g., including VRBs), indicated by the resource allocation, to a set of physical RBGs (e.g., including PRBs). However, in some cases, one or more of the physical RBGs, which may be referred to as partial RBGs, may include one or more first PRBs associated with a first transmission direction and one or more second PRBs associated with a second transmission direction or a guard band 230, or both (e.g., a first subset of the one or more second PRBs may be associated with the second transmission direction and a second subset of the one or more PRBs may be associated with the guard band 230), where the message is associated with the first transmission direction and not the second transmission direction. In such cases, the UE 115 may be unable to determine how to handle the one or more partial RBGs (e.g., whether or not to map to the partial RBGs).

Similarly, in some cases, the network entity 105 may transmit a second control message scheduling a PDSCH (e.g., downlink message) in a set of SBFD symbols in a slot, where the second control message indicates an interleaved (e.g., interleaving is enabled) RIV further indicating a resource allocation (e.g., Type 1 resource allocation) associated with a set of VRB bundles 205. Thus, the UE 115 may attempt to map the set of VRB bundles 205 (e.g., including VRBs), indicated by the resource allocation, to a set of PRB bundles 210 (e.g., including PRBs). However, in some cases, one or more of the PRB bundles 210, which may be referred to as partial PRB bundles 210, may include one or more uplink PRBs (e.g., PRBs associated with an uplink transmission direction), one or more guard-band PRBs (e.g., PRBs associated with a guard band), or both. In such cases, the UE 115 may be unable to determine how to handle the one or more partial PRB bundles 210 (e.g., whether or not to map to the partial PRB bundles 210).

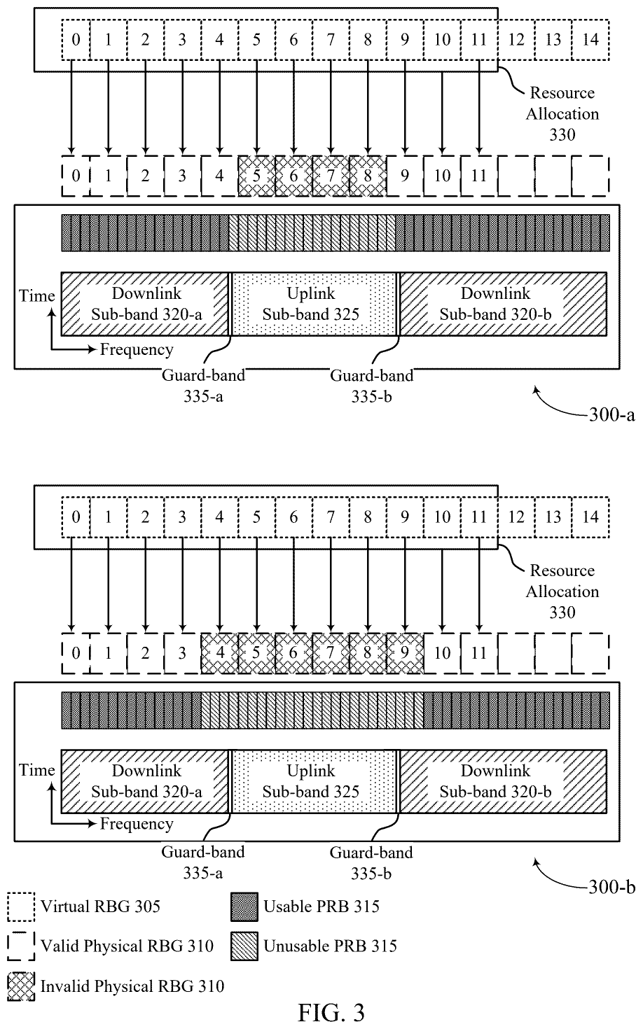

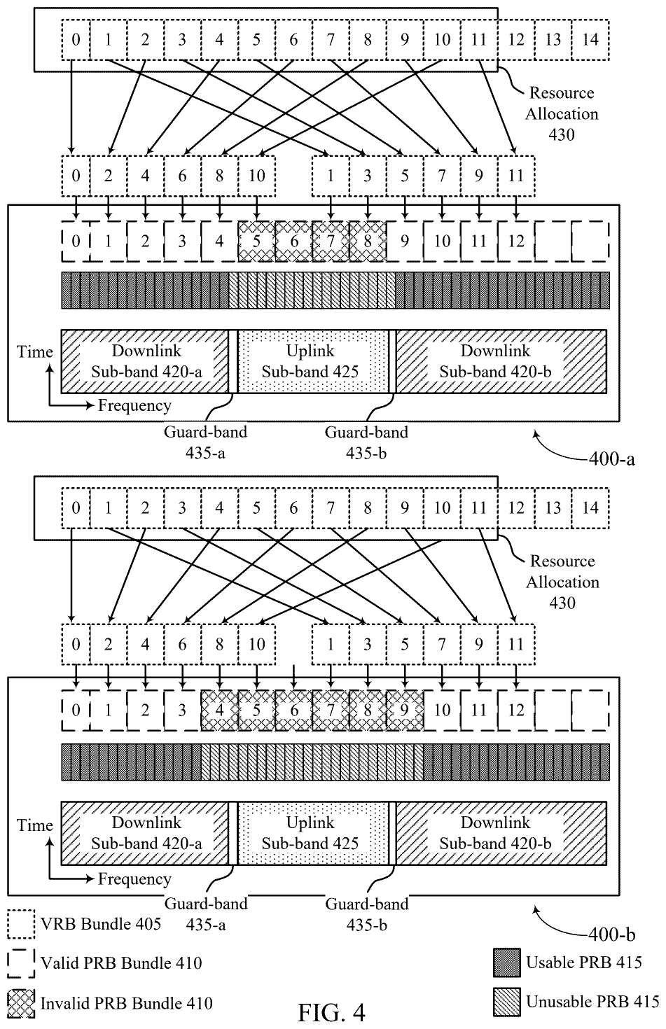

Accordingly, techniques described herein may enable a UE 115 to determine whether to map to at least a portion of a partial RBG (e.g., for DCI format 1_2 or 0_2 with a non-interleaved RIV) or a partial PRB bundle 210 (e.g., for PDSCH scheduling with an interleaved RIV). For example, in some cases, the UE 115 may determine that the partial RBG, as described with reference to FIG. 3, or the partial PRB bundle 210, as described with reference to FIG. 4, is not valid and may not be mapped to based on the partial RBG or the partial PRB bundle 210 including one or more first PRBs associated with a different transmission direction than that of a scheduled message, associated with a guard band 230, or both (e.g., a first subset of the one or more first PRBs may be associated with the different transmission direction and a second subset of the one or more first PRBs may be associated with the guard band 230). In some other cases, the UE 115 may determine that the partial RBG, as described with reference to FIG. 3, or the partial PRB bundle 210, as described with reference to FIG. 4, is valid and may be partially mapped to based on the partial RBG or the partial PRB bundle 210 including one or more second PRBs associated with a same transmission direction as the scheduled message. That is, the UE 115 may determine that the one or more second PRBs (e.g., associated with the same transmission direction) may be used for communication of the scheduled message and the one or more first PRBs (e.g., associated with the different transmission direction, associated with the guard band 230, or both) may not be used for communication of the scheduled message.

FIG. 3 shows examples of resource allocation schemes 300 (e.g., a resource allocation scheme 300-a and a resource allocation scheme 300-b) that support techniques for partial RB bundling and scaling in accordance with one or more aspects of the present disclosure. In some cases, the resource allocation schemes 300 may implement or be implemented by aspects of the wireless communications system 100, the resource allocation schemes 200, or both. For example, the resource allocation schemes 300 may be implemented by one or more UEs 115 and one or more network entities 105, which may be examples of the corresponding devices as described herein.

In some cases, as described with reference to FIGS. 2A, 2B, and 2C, a UE 115 may receive a control message (e.g., DCI format 1_2 or 0_2) scheduling a message (e.g., PUSCH or PDSCH) in a set of SBFD symbols of a slot, where the message is associated with a first transmission direction (e.g., uplink or downlink, respectively). In such cases, the control message may include a non-interleaved RIV (e.g., a non-interleaved frequency domain resource allocation type 1 RIV) of RBG-granularity. That is, the control message may indicate a resource allocation 330 defined by a set of virtual RBGs 305, where interleaving is disabled for mapping of the resource allocation 330. For example, as depicted in the context of the resource allocation scheme 300-a and the resource allocation scheme 300-b, the RIV may indicate an RBG start of 0 and an RBG length of 12, such that the set of virtual RBGs 305 may include a virtual RBG #0 through a virtual RBG #11. Additionally, the UE 115 may determine a block size of each virtual RBG 305 with P={2, 4, 8, 16}.

In such cases, the set of virtual RBGs 305 may correspond to a set of physical RBGs 310. However, due to the SBFD symbols, some of the physical RBGs 310 may include PRBs 315 associated with the first transmission direction, some of the physical RBGs 310 may include PRBs 315 associated with a second transmission direction, some of the physical RBGs 310 may include PRBs 315 be associated with a guard band 335, some of the physical RBGs 310 may include any combination of one or more first PRBs 315 associated with the first transmission direction, one or more second PRBs 315 associated with the second transmission direction, and one or more third PRBs 315 associated with a guard band 335, or any combination thereof. For example, as depicted in the context of a resource allocation scheme 300-a and a resource allocation scheme 300-b, the SBFD symbols may be associated with a downlink sub-band 320-a, a guard band 335-a, an uplink sub-band 325, a guard band 335-b, and a downlink sub-band 320-b. Thus, a first set of physical RBGs 310 (e.g., physical RBG #0 to physical RBG #3 and physical RBG #10 to physical RBG #11) may overlap entirely with the downlink sub-band 320-a or the downlink sub-band 320-b and may include downlink PRBs 315, a second set of physical RBGs 310 (e.g., physical RBG #5 to physical RBG #8) may overlap entirely with the uplink sub-band 325 and may include uplink PRBs 315, and a third set of physical RBGs 310 (e.g., physical RBG #4 and physical RBG #9) may overlap at least partially with a downlink sub-band 320 (e.g., either the downlink sub-band 320-a or the downlink sub-band 320-b) and at least partially with the uplink sub-band 325 (e.g., and may overlap with the guard band 335-a or the guard band 335-b), such that each physical RBG 310 of the third set of physical RBGs 310 may include one or more uplink PRBs 315, one or more downlink PRBs 315, and one or more guard-band PRBs 315. Physical RBGs 310 of the third set of physical RBGs 310 may be referred to as partial RBGs 310.

In some cases, the UE 115 may determine that all PRBs 315 associated with a same transmission direction (e.g., the first transmission direction) as the scheduled message are valid (e.g., may be used) for communication of the scheduled message and that PRBs 315 associated with a different transmission direction (e.g., the second transmission direction) or associated with a guard band 335 are invalid for communication of the scheduled message. In other words, for a partial RBG 310, the one or more first PRBs 315 associated with the first transmission direction may be valid and both the one or more second PRBs 315 associated with the second transmission direction and the one or more third PRBs 315 associated with the guard band 335 may be invalid.

For example, as depicted in the context of the resource allocation scheme 300-a, the control message indicating the resource allocation 330 may schedule a PDSCH, such that uplink PRBs 315 associated with the uplink sub-band 325 and guard-band PRBs 315 associated with the guard bands 335 (e.g., between the downlink sub-bands 320 and the uplink sub-band 325) may be unusable PRBs 315 (e.g., invalid PRBs 315) and downlink PRBs 315 associated with the downlink sub-bands 320 may be usable PRBs 315 (e.g., valid PRBs 315) for PDSCH resource mapping. In other words, physical RBG #5 through physical RBG #8 may be invalid physical RBGs 310 (e.g., not considered for PDSCH resource mapping) based on physical RBG #5 through physical RBG #8 including no downlink PRBs 315 (e.g., all uplink PRBs 315, all guard-band PRBs 315, or a combination of both uplink PRBs 315 and guard-band PRBs 315). Conversely, physical RBG #0 through physical RBG #4 and physical RBG #9 through physical RBG #11 may be valid physical RBGs 310 (e.g., at least partially considered for PDSCH resource mapping) based on physical RBG #0 through physical RBG #4 and physical RBG #9 through physical RBG #11 including at least one downlink PRB 315 (e.g., usable PRB 315). However, as described previously, physical RBG #4 and physical RBG #9 may be partial RBGs 310, such that downlink PRBs 315 of the partial RBGs 310 may be usable PRBs 315 and PRBs 315 of the partial RBGs 310 outside the downlink sub-bands 320 (e.g., uplink PRBs 315 and guard-band PRBs 315) may be unusable PRBs 315. In other words, each partial RBG 310 may include 3 usable and valid PRBs 315 and 1 unusable PRB 315 (e.g., invalid PRB 315). Thus, the UE 115 may perform PDSCH rate matching around unusable PRBs 315.

In such cases, the UE 115 may calculate a TBS associated with the scheduled message based on the partial RBGs 310. In some cases, a quantity of PRBs 315, nPRB, used for TBS calculation may include the usable (e.g., valid) PRBs 315 within the partial RBGs 310. For example, in the context of the resource allocation scheme 300-a, nPRB may equal 29 PRBs 315. That is, for TBS calculation, physical RBG #0 may include 3 usable PRBs 315, each of physical RBG #1 through physical RBG #3 may include 4 usable PRBs 315, physical RBG #4 may include 3 usable PRBs 315, each of physical RBG #5 through physical RBG #8 may include 0 usable PRBs 315, physical RBG #9 may include 3 usable PRBs 315, and each of physical RBG #10 and physical RBG #11 may include 4 usable PRBs 315, such that nPRB=3+3×4+3+0×4+3+2×4=29 usable PRBs 315.

In some other cases, the quantity of PRBs 315, nPRB, used for TBS calculation may consider partial RBGs 310 as full (e.g., normal), valid physical RBGs 310. That is, a valid physical RBG 310 may include a first quantity of usable PRBs 315 and a partial RBG 310 may include a second quantity of usable PRBs 315 less than the first quantity, however, for TBS calculation, the UE 115 may consider the partial RBG 310 as including the first quantity of usable PRBs 315. For example, in the context of the resource allocation scheme 300-a, nPRB may equal 31 PRBs 315. That is, for TBS calculations, physical RBG #0 may include 3 usable PRBs 315, each of physical RBG #1 through physical RBG #4 may include 4 usable PRBs 315 (e.g., physical RBG #4 may be considered to include 4 usable PRBs 315), each of physical RBG #5 through physical RBG #8 may include 0 usable PRBs 315, and each of physical RBG #9 through physical RBG #11 may include 4 usable PRBs 315 (e.g., physical RBG #9 may be considered to include 4 usable PRBs 315), such that nPRB=3+4×4+0×4+3×4=31 usable PRBs 315.

In some other cases, the UE 115 may determine that all PRBs 315 within a partial RBG 310 are not valid and may not be used for resource mapping (e.g., PDSCH resource mapping, PUSCH resource mapping). For example, as depicted in the context of the resource allocation scheme 300-b, the control message indicating the resource allocation 330 may schedule the PDSCH, such that the partial RBGs 310 (e.g., physical RBG #4 and physical RBG #9), including any combination of uplink PRBs 315, downlink PRBs 315, and guard-band PRBs 315, may be invalid physical RBGs 310. In other words, physical RBG #4 through physical RBG #9 may be invalid physical RBGs 310 (e.g., not considered for PDSCH resource mapping) based on physical RBG #4 through physical RBG #9 including at least one uplink PRBs 315, at least one guard-band PRB 315, or both (e.g., unusable PRBs 315). Conversely, physical RBG #0 through physical RBG #3 and physical RBG #10 through physical RBG #11 may be valid physical RBGs 310 (e.g., considered for PDSCH resource mapping) based on physical RBG #0 through physical RBG #3 and physical RBG #10 through physical RBG #11 including all downlink PRB 315 (e.g., usable PRB 315). Thus, the UE 115 may perform PDSCH rate matching around the invalid physical RBGs 310 (e.g., physical RBG #4 through physical RBG #9).

In such cases, the UE 115 may calculate a TBS associated with the scheduled message based on the valid physical RBGs 310. That is, because the partial RBGs 310 are considered invalid physical RBGs 310, the UE 115 may not consider the partial RBGs 310 for TBS calculation. For example, in the context of the resource allocation scheme 300-b, nPRB may equal 23 PRBs 315. That is, for TBS calculations, physical RBG #0 may include 3 usable PRBs 315, each of physical RBG #1 through physical RBG #3 may include 4 usable PRBs 315, each of physical RBG #4 through physical RBG #9 may include 0 usable PRBs 315, and each of physical RBG #10 and physical RBG #11 may include 4 usable PRBs 315, such that nPRB=3+3×4+0×6+2×4=23 usable PRBs 315.

In either case (e.g., partial RBGs 310 are considered at least partially valid physical RBGs 310 or are considered invalid physical RBGs 310), the UE 115 may calculate a size of a last valid physical RBG 310 in the downlink sub-band 320-a (e.g., a first downlink sub-band 320),

$$R B {G}_{first - usableSB}^{s i z e} ,$$

according to the following Equation 2:

$$R B {G}_{first - usable}^{s i z e} = ( {N}_{B WP , i}^{start} + {N}_{{first - usableSB}^{}}^{s i z e} ) mod P \qquad ( 2 )$$

if

$${N}_{B WP , i}^{start} + {N}_{first - usableSB}^{s i z e} > 0 ,$$

otherwise

$$R B {G}_{last}^{s i z e} = P , where {N}_{BWP , i}^{s i z e}$$

may represent a size of a downlink bandwidth part, i,

$${N}_{B WP , i}^{start}$$

may represent a size of downlink BWP (e.g., a downlink sub-band 320),

$${N}_{first - usableSB}^{s i z e}$$

may represent a size of the downlink sub-band 320-a, and P may represent an RBG size. Additionally, the UE 115 may calculate a size of a first valid physical RBG 310 in the downlink sub-band 320-b (e.g., a second downlink sub-band 320).

$$R B {G}_{s e c ond - usableSB}^{s i z e} ,$$

according to the following Equation 3:

$$R B {G}_{s e c ond - usable}^{s i z e} = P - {N}_{s e c ond - usableSB}^{start} mod P \qquad ( 3 )$$

where

$${N}_{s e c ond - usableSB}^{start}$$

may represent a starting PRB 315 of the downlink sub-band 320-b.

Although described and depicted in the context of a control message scheduling a PDSCH, this is not to be regarded as a limitation of the present disclosure. In this regard, the control message may schedule any type of message associated with any transmission direction.

FIG. 4 shows examples of resource allocation schemes 400 (e.g., a resource allocation scheme 400-a and a resource allocation scheme 400-b) that support techniques for partial RB bundling and scaling in accordance with one or more aspects of the present disclosure. In some cases, the resource allocation schemes 400 may implement or be implemented by aspects of the wireless communications system 100, the resource allocation schemes 200, the resource allocation schemes 300, or any combination thereof. For example, the resource allocation schemes 400 may be implemented by one or more UEs 115 and one or more network entities 105, which may be examples of the corresponding devices as described herein.

In some cases, as described with reference to FIGS. 2A, 2B, and 2C, a UE 115 may receive a control message scheduling a PDSCH (e.g., downlink message) in a set of SBFD symbols of a slot. In such cases, the control message may indicate an interleaved RIV (e.g., an interleaved frequency domain resource allocation type 1 RIV) and a VRB bundle size, L, of 2 or 4. That is, the control message may indicate a resource allocation 430 defined by a set of VRB bundles 405, where interleaving is enabled for mapping of the resource allocation 430. For example, as depicted in the context of the resource allocation scheme 400-a and the resource allocation scheme 400-b, the RIV may indicate an RB start of 0, an RB length of 47, and a VRB bundle size of 4, such that the set of VRB bundles 405 may include a VRB bundle #0 through a VRB bundle #11.

In such cases, the set of VRB bundles 405 may correspond to a set of PRB bundles 410. However, due to the SBFD symbols, some of the PRB bundles 410 may include downlink PRBs 415, some of the PRB bundles 410 may include uplink PRBs 415, some of the PRB bundles 410 may include PRBs 315 be associated with a guard band 335, some of the PRB bundles 410 may include any combination of one or more uplink PRBs 415, one or more downlink PRBs 415, and one or more guard-band PRBs 415, or any combination thereof. For example, as depicted in the context of the resource allocation scheme 400-a and the resource allocation scheme 400-b, the SBFD symbols may be associated with a downlink sub-band 420-a, a guard-band 435-a, an uplink sub-band 425, a guard-band 435-b, and a downlink sub-band 420-a. Thus, a first set of PRB bundles 410 (e.g., PRB bundle #0 to PRB bundle #3 and PRB bundle #10 to PRB bundle #12) may overlap entirely with the downlink sub-band 420-a or the downlink sub-band 420-b and may include downlink PRBs 415, a second set of PRB bundles 410 (e.g., PRB bundle #5 to PRB bundle #8) may overlap entirely with the uplink sub-band 425 and may include uplink PRBs 415, and a third set of PRB bundles 410 (e.g., PRB bundle #4 and PRB bundle #9) may overlap at least partially with a downlink sub-band 420 (e.g., either the downlink sub-band 420-a or the downlink sub-band 420-b) and at least partially with the uplink sub-band 425 (e.g., and may overlap with the guard-band 435-a or the guard-band 435-b), such that each PRB bundle 410 of the third set of PRB bundles 410 may include one or more uplink PRBs 415, one or more downlink PRBs 415, and one or more guard-band PRBs 415. PRB bundles 410 of the third set of PRB bundles 410 may be referred to as partial PRB bundles 410.

In some cases, the UE 115 may determine that all downlink PRBs 415 are valid (e.g., may be used) for communication of the PDSCH and that both uplink PRBs 415 and guard-band PRBs 415 are invalid for communication of the PDSCH. In other words, for a partial PRB bundle 410, the one or more downlink PRBs 415 may be valid and both the one or more uplink PRBs 415 and the one or more guard-band PRBs 415 may be invalid.

For example, as depicted in the context of the resource allocation scheme 400-a, the control message indicating the resource allocation 430 may schedule the PDSCH, such that uplink PRBs 415 associated with the uplink sub-band 425 and guard-band PRBs 415 associated with the guard-bands 435 may be unusable PRBs 415 (e.g., invalid PRBs 415) and downlink PRBs 415 associated with the downlink sub-bands 420 may be usable PRBs 415 (e.g., valid PRBs 415). In other words, PRB bundle #5 through PRB bundle #8 (e.g., corresponding to VRB bundle #10, #1, and #3) may be invalid PRB bundles 410 based on PRB bundle #5 through PRB bundle #8 including no downlink PRBs 415 (e.g., all uplink PRBs 415, all guard-band PRBs 415, or a combination of both uplink PRBs 415 and guard-band PRBs 415). Conversely, PRB bundle #0 through PRB bundle #4 and PRB bundle #9 through PRB bundle #12 (e.g., corresponding to VRB bundles #0, #2, #4, #6, #8, #5, #7, #9, #11) may be valid PRB bundles 410 based on PRB bundle #0 through PRB bundle #4 and PRB bundle #9 through PRB bundle #12 including at least one downlink PRB 415 (e.g., usable PRB 415). However, as described previously, PRB bundle #4 (e.g., corresponding to VRB bundle #8) and PRB bundle #9 (e.g., corresponding to VRB bundle #5) may be partial PRB bundles 410, such that downlink PRBs 415 of the partial PRB bundles 410 may be usable PRBs 415 and PRBs 415 of the partial PRB bundles 410 outside of the downlink sub-band 320 (e.g., uplink PRBs 415 and guard-band PRBs 415) may be unusable PRBs 415. In other words, each partial PRB bundle 410 may include 3 usable and valid PRBs 415 and 1 unusable PRB 415 (e.g., invalid PRBs 415).

In such cases, the UE 115 may calculate a TBS associated with the PDSCH based on the partial PRB bundles 410. In some cases, a quantity of PRBs 415, nPRB, used for TBS calculation may include the usable PRBs 415 (e.g., valid PRBs 415) within the partial PRB bundles 410. For example, in the context of the resource allocation scheme 400-a, nPRB may equal 33 PRBs 415. That is, for TBS calculation, PRB bundle #0 may include 3 usable PRBs 415, each of PRB bundle #1 through PRB bundle #3 may include 4 usable PRBs 415, PRB bundle #4 may include 4 usable PRBs 415, each of PRB bundle #5 through PRB bundle #8 may include 0 usable PRBs 415, PRB bundle #9 may include 4 usable PRBs 415, and each of PRB bundle #10 and PRB bundle #12 may include 4 usable PRBs 415, such that nPRB=3+3×4+4+0×3+3+3×4=33 usable PRBs 415.

In some other cases, the quantity of PRBs 415, nPRB, used for TBS calculation may consider partial PRB bundles 410 as full (e.g., normal), valid PRB bundles 410. That is, a valid PRB bundle 410 may include a first quantity of usable PRBs 415 and a partial PRB bundle 410 may include a second quantity of usable PRBs 415 less than the first quantity, however, for TBS calculation, the UE 115 may consider the partial PRB bundle 410 as including the first quantity of usable PRBs 415. For example, in the context of the resource allocation scheme 400-a, nPRB may equal 35 PRBs 415. That is, for TBS calculations, PRB bundle #0 may include 3 usable PRBs 415, each of PRB bundle #1 through PRB bundle #4 may include 4 usable PRBs 415 (e.g., PRB bundle #4 may be considered to include 4 usable PRBs 415), each of PRB bundle #5 through PRB bundle #8 may include 0 usable PRBs 415, and each of PRB bundle #9 through PRB bundle #12 may include 4 usable PRBs 415 (e.g., PRB bundle #9 may be considered to include 4 usable PRBs 415), such that nPRB=3+4×4+0×3+4×4=35 usable PRBs 415.

In some other cases, the UE 115 may determine that all PRBs 415 within a partial PRB bundle 410 are not valid and may not be used for resource mapping (e.g., PDSCH resource mapping). For example, as depicted in the context of the resource allocation scheme 400-b, the control message indicating the resource allocation 430 may schedule the PDSCH, such that the partial PRB bundles 410 (e.g., PRB bundle #4 and PRB bundle #9), including any combination of uplink PRBs 415, downlink PRBs 415, and guard-band PRBs 415, may be invalid PRB bundles 410. In other words, PRB bundle #4 through PRB bundle #9 may be invalid PRB bundles 410 (e.g., not considered for PDSCH resource mapping) based on PRB bundle #4 through PRB bundle #9 including at least one uplink PRBs 415, at least one guard-band PRB 415, or both (e.g., unusable PRBs 415). Conversely, PRB bundle #0 through PRB bundle #3 and PRB bundle #10 through PRB bundle #1 may be valid PRB bundles 410 (e.g., considered for PDSCH resource mapping) based on PRB bundle #0 through PRB bundle #3 and PRB bundle #10 through PRB bundle #12 including all downlink PRB 415 (e.g., usable PRB 415).

In such cases, the UE 115 may calculate a TBS associated with the scheduled message based on the valid PRB bundles 410. That is, because the partial PRB bundles 410 are considered invalid PRB bundles 410, the UE 115 may not consider the partial PRB bundles 410 for TBS calculation. For example, in the context of the resource allocation scheme 400-b, nPRB may equal 27 PRBs 415. That is, for TBS calculations, PRB bundle #0 may include 3 usable PRBs 415, each of PRB bundle #1 through PRB bundle #3 may include 4 usable PRBs 415, each of PRB bundle #4 through PRB bundle #9 may include 0 usable PRBs 415, and each of PRB bundle #10 through PRB bundle #12 may include 4 usable PRBs 415, such that nPRB=3+3×4+0×5+3×4=27 usable PRBs 415.

In either case (e.g., partial PRB bundles 410 are considered at least partially valid PRB bundles 410 or are considered invalid PRB bundles 410), the UE 115 may calculate a size of a last valid PRB bundle 410 in the downlink sub-band 420-a (e.g., a first downlink sub-band 420),

$${Bundle}_{first - usableSB}^{s i z e} ,$$

according to the following Equation 4:

$${Bundle}_{first - usableSB}^{s i z e} = ( {N}_{B WP , i}^{start} + {N}_{first - usableSB}^{s i z e} ) mod L \qquad ( 4 )$$

if

$${N}_{BWP , i}^{start} + {N}_{first - usableSB}^{s i z e} > 0 ,$$

otherwise

$$R B {G}_{last}^{s i z e} = L ,$$

where

$${N}_{BWP , i}^{s i z e}$$

may represent a size of a downlink bandwidth part, i,

$${N}_{B WP , i}^{start}$$

may represent a first PRB 415 of a downlink BWP (e.g., a downlink sub-band 420),

$${N}_{first - usable SB}^{s i z e}$$

may represent a size of the downlink sub-band 420-a, and L may represent a bundle size. Additionally, the UE 115 may calculate a size of a first valid PRB bundle 410 in the downlink sub-band 420-b (e.g., a second downlink sub-band 420)

$${Bundle}_{s e c ond - usableSB}^{s i z e}$$

according to the following Equation 5:

$${Bundle}_{s e c ond - usable SB}^{s i z e} = L - {N}_{s e c ond - usableSB}^{start} mod L \qquad ( 5 )$$

where

$${N}_{s e c ond - usableSB}^{start}$$

may represent a starting PRB 415 of the downlink sub-band 420-b.

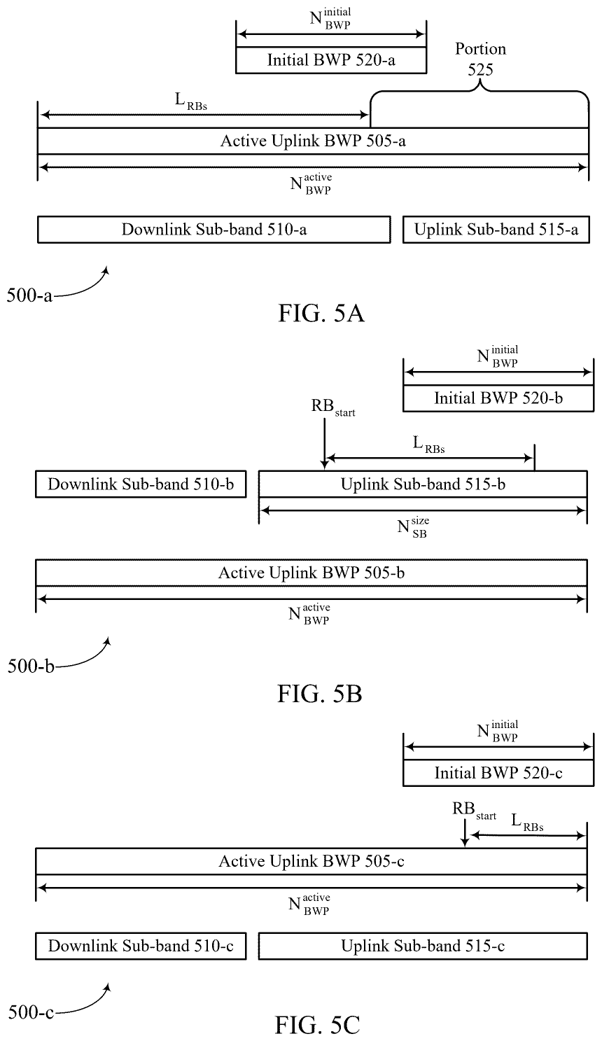

FIGS. 5A, 5B, and 5C shows examples of resource allocations 500 (e.g., a resource allocation 500-a and a resource allocation 500-b) that support techniques for partial RB bundling and scaling in accordance with one or more aspects of the present disclosure. In some cases, the resource allocations 500 may implement or be implemented by aspects of the wireless communications system 100, the resource allocation schemes 200, the resource allocation schemes 300, the resource allocation schemes 400, or any combination thereof. For example, the resource allocations 500 may be implemented by one or more UEs 115 and one or more network entities 105, which may be examples of the corresponding devices as described herein.

In some cases, as described with reference to FIGS. 2A, 2B, 2C, 3, and 4, a UE 115 may receive a control message (e.g., fallback DCI) indicating a RIV, where the RIV indicates a first starting RB,

$${RB}_{start}^{′} ,$$

and a first size

$${L}_{RBs}^{′} ,$$

(e.g., in a quantity of RBs). In such cases, a resource allocation 500 may be a multiple, K, of the first starting RB,

$${RB}_{start}^{′} ,$$

and the first size,

$${L}_{RBs}^{′} ,$$

indicated by the RIV. That is, the resource allocation 500 may be associated with a second starting RB, RBₛₜₐᵣₜ, and a second length, L_{RBs}, where

$${RB}_{start} = K \times {RB}_{start}^{′}$$

$$and$$

$${L}_{RBs} = K \times {L}_{RBs}^{′} .$$

For example, when a first control message size (e.g., DCI size) for a control message (e.g., DCI format 1_0 or 0_0) in USS is derived from a second control message size for the control message in a common search space (CSS) but applied to an active BWP with a size of

$${N}_{B W P}^{s i z e} ,$$

a field (e.g., a downlink type 1 RB assignment field) in the control message may include a RIV corresponding to a starting RB, RBₛₜₐᵣₜ, of a resource allocation, where RBₛₜₐᵣₜ=0, K, 2·K, . . . ,

$$( {N}_{B W P}^{initial} - 1 ) .$$

K, and a length in terms of virtually contiguous allocated RBs, L_{RBs}, where L_{RBs}=K,2·K, . . . ,

$${N}_{B W P}^{initial} \cdot K .$$

In such cases,

$${N}_{B W P}^{initial}$$

may be defined by a size of a first CORESET (e.g., CORESET 0), if the first CORESET is configured (e.g., for a cell), or may be defined by a size of an initial downlink BWP is the first CORESET is not configured. In such cases, the RIV may be defined by

$$RIV = {N}_{BWP}^{initial} ( {L}_{RBs}^{′} - 1 ) + {RB}_{start}^{′} if ( {L}_{RBs}^{′} - 1 ) \leq ⌊ {N}_{BWP}^{nitital} / 2 ⌋$$

or by

$$RIV = {N}_{B W P}^{initial} ( {N}_{B W P}^{initial} - {L}_{R B s}^{′} + 1 ) + ( {N}_{B W P}^{initial} - 1 - R {B}_{start}^{′} )$$

otherwise. In either case, as described previously,

$${L}_{R B s}^{′} = {L}_{R B s} / K and {RB}_{start}^{′} = R {B}_{start} / K ,$$

where

$${L}_{RBs}^{′}$$

may not exceed

$${N}_{BWP}^{initial} - {RB}_{start}^{′} .$$

### Additionally, if

$${N}_{BWP}^{active} > {N}_{BWP}^{initial} ,$$

K may be a threshold value (e.g., maximum value) from a set {1, 2, 4, 8} that satisfies

$$K = ⌊ {N}_{BWP}^{active} / {N}_{BWP}^{initial} ⌋ ,$$

otherwise K=1.

However, in some cases, not all of an active BWP may be assigned in SBFD symbols. That is, an active BWP may include one or more downlink sub-bands 215 and one or more uplink sub-bands 220, such that a subset of resources associated with the active BWP may not be available (e.g., used) for communication of a scheduled message due to the subset of resources being associated with a different transmission direction than the scheduled message. In such cases, a network entity 105 may not be able to signal a given allocation within usable PRBs.

For example, as depicted in FIG. 5A, a UE 115 may be associated with an initial BWP 520-a with a size

$${N}_{BWP}^{initial}$$

and an active uplink BWP 505-a with a size

$${N}_{BWP}^{active} ,$$

where

$$⌊ {N}_{BWP}^{active} / {N}_{BWP}^{initial} ⌋ = 7$$

and K=4 such that

$${L}_{RBs} = 4 \times {L}_{RBs}^{′} .$$

Thus, 3/7 of the active uplink BWP 505-a may be assigned for signaling (e.g., may be signaled as part of the resource allocation 500-a). However, resources in a portion 525 of the uplink BWP 505-a may not be assigned for signaling (e.g., may not be signaled as part of the resource allocation 500-a). Thus, when the UE 115 is configured with SBFD slots associated with a downlink sub-band 510-a and an uplink sub-band 515-a, the network entity 105 may be unable to signal resources associated with the uplink sub-band 515-a based on the resources being within the portion 525.

Accordingly, techniques described herein may support interpretation of RIVs in the presence of SBFD slots. For example, a first control message size (e.g., DCI size) for a control message (e.g., DCI format 1_0 or 0_0) in USS may be derived from a second control message size of the control message in CSS, but may be applied to an active BWP with size

$${N}_{BWP}^{active} .$$

In such cases, a field (e.g., downlink type 1 RB assignment field) in the control message may include a RIV corresponding to a starting RB, RBₛₜₐᵣₜ, of a resource allocation 500 and a length in terms of virtually contiguous allocated RBs, L_{RBs}, associated with the resource allocation 500.

In some cases, a value of K may be determined based on a size of usable PRBs (e.g., associated with a same transmission direction as a scheduled message). That is, the usable PRBs may be associated with a sub-band with a size N_{SB}, such that if

$${N}_{SB} > {N}_{BWP}^{initial} ,$$

K may be a threshold (e.g., maximum) value from a set {1, 2, 4, 8} that satisfies

$$K = ⌊ {N}_{SB} / {N}_{BWP}^{initial} ⌋ ,$$

otherwise K=1. Further, the UE 115 may interpret a starting RB, RBₛₜₐᵣₜ, of a resource allocation 500, such as the resource allocation 500-a, and a length, L_{RBs}, of the resource allocation 500 within the usable PRBs.

For example, as depicted in FIG. 5B, the UE 115 may be associated with an initial BWP 520-b of size

$${N}_{BWP}^{initial}$$

and an active uplink BWP 505-b of size

$${N}_{BWP}^{active} .$$

However, the UE 115 may be scheduled with an uplink message via an SBFD symbol (e.g., or slot), where the SBFD symbol is associated with a downlink sub-band 510-b and an uplink sub-band 515-b. Thus, the downlink sub-band 510-b may be associated with unusable PRBs and the uplink sub-band 515-b may be associated with usable PRBs. Additionally, a size of the uplink sub-band 515-b (e.g., usable PRBs) may be N_{SB} where

$${N}_{SB} > {N}_{BWP}^{initial} .$$

As such, the UE 115 may determine

$$K \leq ⌊ {N}_{SB} / {N}_{BWP}^{initial} ⌋ = 2$$

and may use K in conjunction with

$$R {B}_{start}^{′} and {L}_{RBs}^{′}$$

indicated by a RIV to determine a starting RB, RBₛₜₐᵣₜ, of a resource allocation 500-b and a length in terms of virtually contiguous allocated RBs, L_{RBs}, associated with the resource allocation 500-b. That is, the starting RB, RBₛₜₐᵣₜ, of the resource allocation 500-b may be equal to

$$2 \times R {B}_{start}^{′}$$

and the length, L_{RBs}, of the resource allocation 500-b may be equal to

$$2 \times {L}_{RBs}^{′} ,$$

where both the starting RB, RBₛₜₐᵣₜ, and the length, L_{RBs}, are relative to a first RB of the uplink sub-band 515-b (e.g., interpreted within the uplink sub-band 515-b). In other words, the starting RB, RBₛₜₐᵣₜ, of the resource allocation 500-b may be offset from the starting RB of the uplink sub-band 515-b.

In some other cases, the UE 115 may interpret an RIV indicated in a control message based on a size,

$${N}_{BWP}^{active} ,$$

of an active BWP. That is, the UE 115 may determine a starting RB, RBₛₜₐᵣₜ, of a resource allocation 500, such as the resource allocation 500-b, according to the following Equation 6:

$${RB}_{start} = K \times {RB}_{start}^{′} + {RB}_{offset} \qquad ( 6 )$$

In such cases, the UE 115 may receive a control message (e.g., RRC configuration, DCI) indicating RB_{offset}, the UE 115 may determine RB_{offset} based on a first usable PRB in a sub-band with a same transmission direction as a scheduled message, RB_{offset} may be relative to the first usable PRB, or any combination thereof. In some examples, the RB_{offset} may be indicated to the UE 115 explicitly by one or more RRC parameters. Additionally, or alternatively, a scheduling DCI may include a bitfield to indicate to the UE 115 whether to apply the RB_{offset} for the calculation of the starting RB. For example, as depicted below, a value of 1 in the bitfield may indicate for the UE 115 to apply the RB_{offset} and a value of 0 in the bitfield may indicate for the UE 115 to not apply the RB_{offset}.

$${RB}_{start} = \{ \begin{matrix}K \times {RB}_{start}^{′} + {RB}_{offset} , & bitfiled ‘ 1 ’ \\ \begin{matrix}K \times {RB}_{start}^{′} , & bitfield ‘ 0 ’\end{matrix} & \end{matrix}$$

In some examples, the UE 115 may determine whether to apply the RB_{offset} based on whether a quantity of allocated PRBs is greater than or less than a threshold. Additionally, or alternatively, in case of an absence of the bitfield in the scheduling DCI, the UE 115 may apply (e.g., or not apply) the RB_{offset} based on a default configuration (e.g., default behavior).

For example, as depicted in FIG. 5C, the UE 115 may be associated with an initial BWP 520-c of size

$${N}_{BWP}^{initial}$$

and an active uplink BWP 505-c of size

$${N}_{BWP}^{active} .$$

However, the UE 115 may be scheduled with an uplink message via an SBFD symbol (e.g., or slot), where the SBFD symbol is associated with a downlink sub-band 510-c and an uplink sub-band 515-c. Thus, the downlink sub-band 510-c may be associated with unusable PRBs and the uplink sub-band 515-c may be associated with usable PRBs (e.g., the uplink sub-band may include the first usable PRB). As such, the UE 115 may determine a starting RB, RBₛₜₐᵣₜ, of a resource allocation 500-c as

$$K \times {RB}_{start}^{′} + {RB}_{offset}$$

and may determine a length in terms of virtually contiguous allocated RBs, L_{RBs}, associated with the resource allocation 500-c as

$$K \times {L}_{RBs}^{′} ,$$

where both the starting RB, RBₛₜₐᵣₜ, and the length, L_{RBs}, are relative to a first RB of the active uplink BWP 505-c (e.g., interpreted within the active uplink BWP 505-c). In other words, the RB_{offset} may be large enough that the starting RB, RBₛₜₐᵣₜ, is an RB associated with the uplink sub-band 515-c.

In some other cases, K may be pre-configured at the UE 115 and may be one of a set {1,2,3,4,5,6,7,8}.

Though described in the context of active uplink BWPs 505 this is not to be regarded as a limitation of the present disclosure. In this regard, an active BWP may be an active downlink BWP, such that usable PRBs are associated with a downlink sub-band 510.

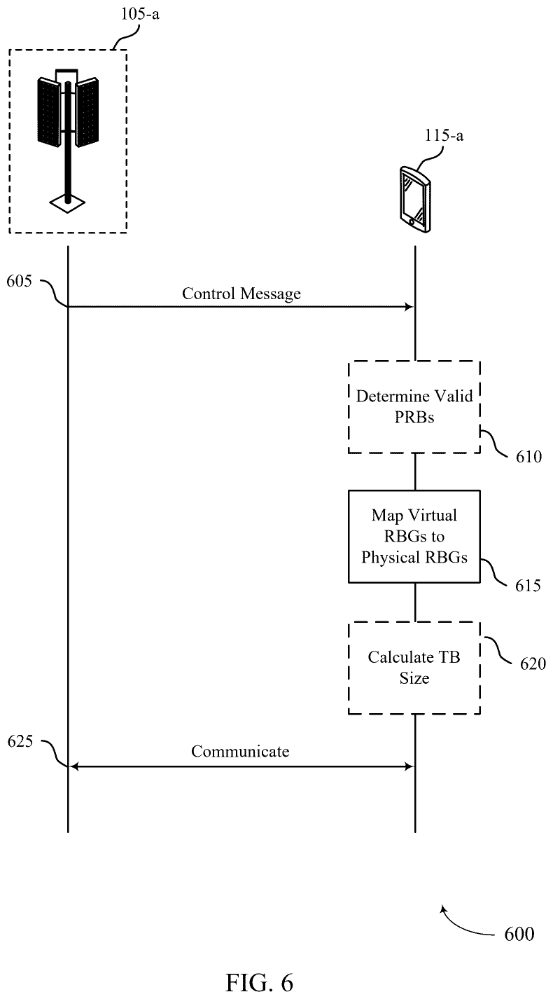

FIG. 6 shows an example of a process flow 600 that supports techniques for partial RB bundling and scaling in accordance with one or more aspects of the present disclosure. In some cases, the process flow 600 may implement or be implemented by aspects of the wireless communications system 100, the resource allocation schemes 200, the resource allocation schemes 300, the resource allocation schemes 400, the resource allocations 500, or any combination thereof. For example, the process flow 600 may include one or more UEs 115 (e.g., a UE 115-a) and one or more network entities 105 (e.g., a network entity 105-a), which may be examples of the corresponding devices as described herein. In the following description of the process flow 600, the operations between the UE 115-a and the network entity 105-a may be transmitted in a different order than the example order shown, or the operations performed by the UE 115-a and the network entity 105-a may be performed in different orders or at different times. Some operations may also be omitted from the process flow 600, and other operations may be added to the process flow 600.

At operation 605, the UE 115-a may receive, from the network entity 105-a via an SBFD slot, a control message (e.g., DCI format 1_2 or DCI format 0_2) scheduling a first message (e.g., PUSCH or PDSCH) associated with a first transmission direction (e.g., uplink or downlink, respectively), where the control message includes a non-interleaved RIV indicating a starting virtual RBG and a set of contiguous virtual RBGs. In such cases, the first message may be scheduled in a set of SBFD symbols in a slot.

At operation 610, the UE 115-a may determine whether at least a portion of a first physical RBG is used for communication of the first message (e.g., is valid, is usable). In such cases, the determination may be based on the first physical RBG including one or more first PRBs associated with a first transmission direction (e.g., uplink or downlink) and one or more second PRBs associated with a second transmission direction (e.g., downlink or uplink, respectively) or a guard-band, or both.

For example, in some cases, the UE 115-a may determine that at least the portion of the first physical RBG is used for communication based on the at least portion of the first physical RBG including the one or more first PRBs associated with the first transmission direction. Conversely, the UE 115-a may determine the first physical RBG is not used for communication based on the first physical RBG including the one or more second PRBs associated with the second transmission direction or a guard-band, or both.

At operation 615, the UE 115-a may map the set of contiguous virtual RBGs to a set of physical RBGs based on the determination of whether at least the portion of the first physical RBG is used (e.g., is available) for communication of the first message. That is, the set of physical RBGs may include the first physical RBG based on determining the one or more first PRBs associated with the first transmission direction are used for communication of the first message or may not include the first physical RBG based on determining the first physical RBG (e.g., both the one or more first PRBs and the one or more second PRBs) is not used for communication of the first message.

In some examples, the SBFD slot may include both a first sub-band and a second sub-band associated with the first transmission direction. In such cases, a size of a last physical RBG associated with the first sub-band (e.g., from a first subset of the set of physical RBGs) may be based on a starting RB associated with the SBFD slot, a quantity of RBs associated with the first sub-band, a size of each physical RBG of the set of physical RBGs, or any combination thereof. Additionally, a size of a starting physical RBG associated with the second sub-band (e.g., from a second subset of the set of physical RBGs) may be based on the size of each RBG of the set of physical RBGs, a first RB associated with the second sub-band, or both.

In some cases, at operation 620, the UE 115-a may calculate a TBS associated with the first message. In some cases, the UE 115-a may calculate the TBS associated with the first message based on a first quantity of PRBs, where the first quantity of PRBs includes the one or more first PRBs and excludes the one or more second PRBs. In some other cases, the UE 115-a may calculate the TBS associated with the first message based on a second quantity of PRBs, where the second quantity of PRBs includes both the one or more first PRBs and the one or more second PRBs. In some other cases, the UE 115-a may calculate the TBS associated with the first message based on a third quantity of PRBs, where the third quantity of PRBs excludes both the one or more first PRBs and the one or more second PRBs.

Thus, at operation 625, the UE 115-a may communicate (e.g., transmit or receive) the first message based on the set of contiguous virtual RBGs being mapped to the set of physical RBGs.

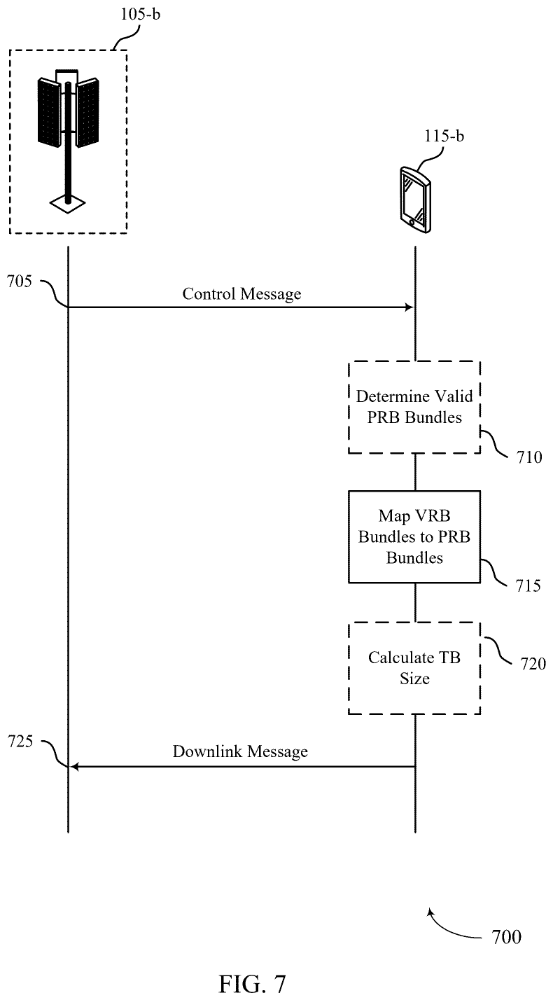

FIG. 7 shows an example of a process flow 700 that supports techniques for partial RB bundling and scaling in accordance with one or more aspects of the present disclosure. In some cases, the process flow 700 may implement or be implemented by aspects of the wireless communications system 100, the resource allocation schemes 200, the resource allocation schemes 300, the resource allocation schemes 400, the resource allocations 500, the process flow 600, or any combination thereof. For example, the process flow 700 may include one or more UEs 115 (e.g., a UE 115-b) and one or more network entities 105 (e.g., a network entity 105-b), which may be examples of the corresponding devices as described herein. In the following description of the process flow 700, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 700, and other operations may be added to the process flow 700.

At operation 705, the UE 115-b may receive, from the network entity 105-b via an SBFD slot, a control message scheduling a downlink message, where the control message includes an interleaved RIV indicating a starting VRB bundle and a set of contiguous VRB bundles. In such cases, the first message may be scheduled in a set of SBFD symbols in a slot.

At operation 710, the UE 115-b may determine whether at least a portion of a first PRB bundle is used for communication of the downlink message (e.g., is valid, is usable). In such cases, the determination may be based on the first PRB bundle including one or more downlink PRBs and one or more uplink PRBs.

For example, in some cases, the UE 115-b may determine that at least the portion of the first PRB bundle is used for communication based on at least the portion of the first PRB bundle including the one or more downlink PRBs. Conversely, the UE 115-b may determine the first PRB bundle is not used for communication based on the first PRB bundle including the one or more uplink PRBs.

At operation 715, the UE 115-b may map the set of contiguous VRB bundles to a set of PRB bundles based on the determination of whether at least the portion of the first PRB bundle is used for communication of the first message. That is, the set of PRB bundles may include the first PRB bundle based on determining the one or more downlink PRBs are used for communication of the first message or may not include the first PRB bundle based on determining the first PRB bundle (e.g., both the one or more downlink PRBs and the one or more uplink PRBs) is not used for communication of the first message.

In some examples, the SBFD slot may include both a first sub-band and a second sub-band associated with the first transmission direction. In such cases, a size of a last PRB bundle associated with the first sub-band (e.g., from a first subset of the set of PRB bundles) may be based on a starting RB associated with the SBFD slot, a quantity of RBs associated with the first sub-band, a size of each PRB bundle of the set of PRB bundles, or any combination thereof. Additionally, a size of a starting PRB bundle associated with the second sub-band (e.g., from a second subset of the set of PRB bundles) may be based on the size of each RBG of the set of PRB bundles, a first RB associated with the second sub-band, or both.

In some cases, at operation 720, the UE 115-b may calculate a TBS associated with the first message. In some cases, the UE 115-b may calculate the TBS associated with the first message based on a first quantity of PRBs, where the first quantity of PRBs includes the one or more downlink PRBs and excludes the one or more uplink PRBs. In some other cases, the UE 115-b may calculate the TBS associated with the first message based on a second quantity of PRBs, where the second quantity of PRBs includes both the one or more downlink PRBs and the one or more uplink PRBs. In some other cases, the UE 115-b may calculate the TBS associated with the first message based on a third quantity of PRBs, where the third quantity of PRBs excludes both the one or more downlink PRBs and the one or more uplink PRBs.

Thus, at operation 725, the UE 115-b may receive, from the network entity 105-b, the downlink message based on the set of contiguous VRB bundles being mapped to the set of PRB bundles.

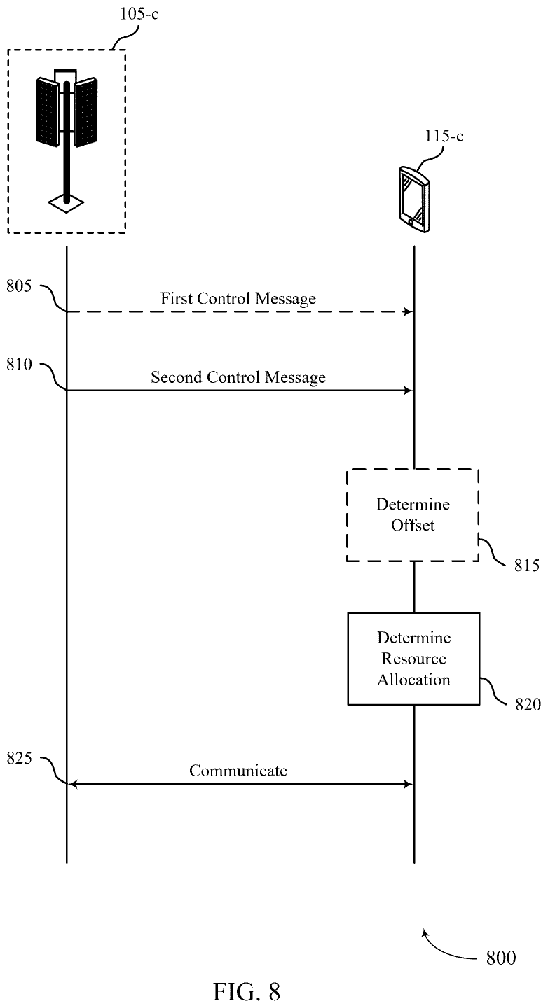

FIG. 8 shows an example of a process flow 800 that supports techniques for partial RB bundling and scaling in accordance with one or more aspects of the present disclosure. In some cases, the process flow 800 may implement or be implemented by aspects of the wireless communications system 100, the resource allocation schemes 200, the resource allocation schemes 300, the resource allocation schemes 400, the resource allocations 500, the process flow 600, the process flow 700, or any combination thereof. For example, the process flow 800 may include one or more UEs 115 (e.g., a UE 115-c) and one or more network entities 105 (e.g., a network entity 105-c), which may be examples of the corresponding devices as described herein. In the following description of the process flow 800, the operations between the UE 115-c and the network entity 105-c may be transmitted in a different order than the example order shown, or the operations performed by the UE 115-c and the network entity 105-c may be performed in different orders or at different times. Some operations may also be omitted from the process flow 800, and other operations may be added to the process flow 800.

At operation 805, the UE 115-c may receive, from the network entity 105-c, a first control message (e.g., RRC message, DCI message) indicating an RB offset.

In some cases, at operation 810, the UE 115-c may receive, from the network entity 105-c via an SBFD slot, a second control message (e.g., DCI format 0_0 or DCI format 1_0) scheduling a first message associated with a first transmission direction, where the second control message includes a RIV indicating a starting RB and a set of contiguous RBs. In some cases, the first message may be scheduled via a set of SBFD symbols.

In some cases, at operation 815, the UE 115-c may determine the RB offset. In some cases, the UE 115-c may determine the RB offset based on a first RB in a sub-band associated with the first transmission direction.

At operation 820, the UE 115-c may determine a starting RB of a resource allocation and a length of the resource allocation based on an integer value (e.g., K). In such cases, the integer value may be based on a first quantity of RBs (e.g., of the resource allocation) associated with the first transmission direction, a size of an active BWP associated with the UE 115-c, a predefined value, or any combination thereof.

In some cases, the first quantity of RBs associated with the first transmission direction (e.g., usable RBs) may be greater than a second quantity of RBs associated with an initial BWP. In such cases, the integer value may be equal to a threshold value (e.g., maximum value) of {1, 2, 4, 8} that satisfies the integer value being less than or equal to a floor of the first quantity of RBs associated with the first transmission direction divided by the second quantity of RBs associated with an initial BWP. In some other cases, the first quantity of RBs associated with the first transmission direction (e.g., usable RBs) may be less than the second quantity of RBs associated with the initial BWP. In such cases, the integer value may equal 1. In either case, both the starting RB and the length of the resource allocation may be within the first quantity of RBs associated with the first transmission direction.

In some other cases, the starting RB may be equal to an offset added to a product of the integer value and the starting RB. Additionally, or alternatively, the starting RB may be relative to a first RB in the sub-band associated with the first transmission direction.

In some other cases, the predefined value may be equal to 1, 2, 3, 4, 5, 6, 7, or 8.

Thus, at operation 825, the UE 115-c may communicate the first message in accordance with the resource allocation.

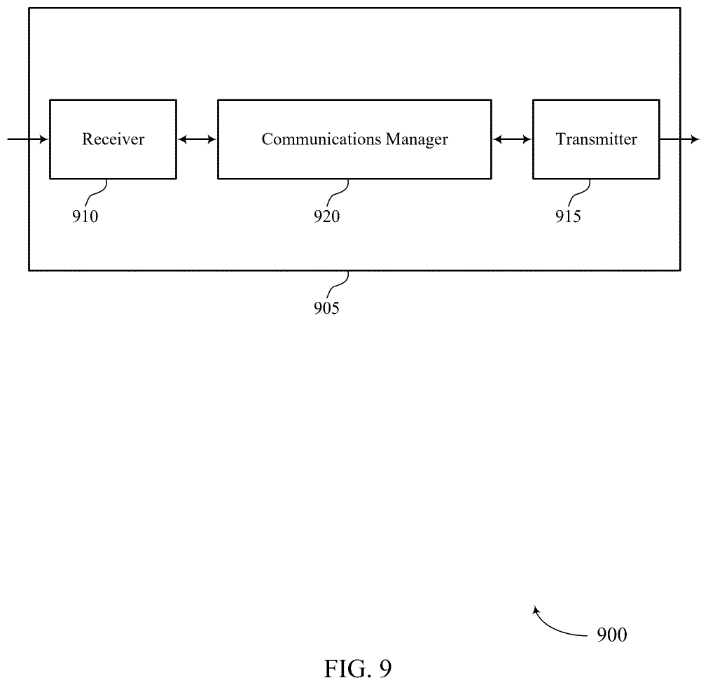

FIG. 9 shows a block diagram 900 of a device 905 that supports techniques for partial RB bundling and scaling in accordance with one or more aspects of the present disclosure. The device 905 may be an example of aspects of a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for partial RB bundling and scaling). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for partial RB bundling and scaling). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations or components thereof may be examples of means for performing various aspects of techniques for partial RB bundling and scaling as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for receiving, via a SBFD slot, a control message scheduling a first message associated with a first transmission direction, where the control message includes a non-interleaved RIV indicating a starting virtual RBG and a set of contiguous virtual RBGs. The communications manager 920 is capable of, configured to, or operable to support a means for mapping the set of contiguous virtual RBGs to a set of physical RBGs based on a determination of whether at least a portion of a first physical RBG is used for communication of the first message, and where the determination is based on the first physical RBG including one or more first PRBs associated with the first transmission direction (e.g., and one or more second PRBs associated with at least one of a second transmission direction or a guard-band). The communications manager 920 is capable of, configured to, or operable to support a means for communicating the first message based on the set of contiguous virtual RBGs being mapped to the set of physical RBGs.

Additionally, or alternatively, the communications manager 920 may support wireless communications in accordance with examples as disclosed herein. For example, the communications manager 920 is capable of, configured to, or operable to support a means for receiving, via a SBFD slot, a control message scheduling a downlink message, where the control message includes an interleaved RIV indicating a starting VRB bundle and a set of VRB bundles. The communications manager 920 is capable of, configured to, or operable to support a means for mapping the set of VRB bundles to a set of PRB bundles based on a determination of whether at least a portion of a first PRB bundle is used for communication of the downlink message, where the determination is based on the first PRB bundle including one or more downlink PRBs and one or more uplink PRBs. The communications manager 920 is capable of, configured to, or operable to support a means for receiving the downlink message based on the set of VRB bundles being mapped to the set of PRB bundles.

Additionally, or alternatively, the communications manager 920 may support wireless communications in accordance with examples as disclosed herein. For example, the communications manager 920 is capable of, configured to, or operable to support a means for receiving, via a SBFD slot, a control message scheduling a first message, where the control message includes a RIV indicating a first starting RB and a set of contiguous RBs. The communications manager 920 is capable of, configured to, or operable to support a means for determining a second starting RB of a resource allocation and a length of the resource allocation based on an integer value, where the integer value is based on a first quantity of RBs of the resource allocation, a size of an active bandwidth part, a predefined value, or any combination thereof. The first quantity of RBs is associated with a first transmission direction. The communications manager 920 is capable of, configured to, or operable to support a means for communicating the first message in accordance with the resource allocation.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for partial RB bundling and scaling, which may result in reduced processing, reduced power consumption, and more efficient utilization of communication resources, among other advantages.

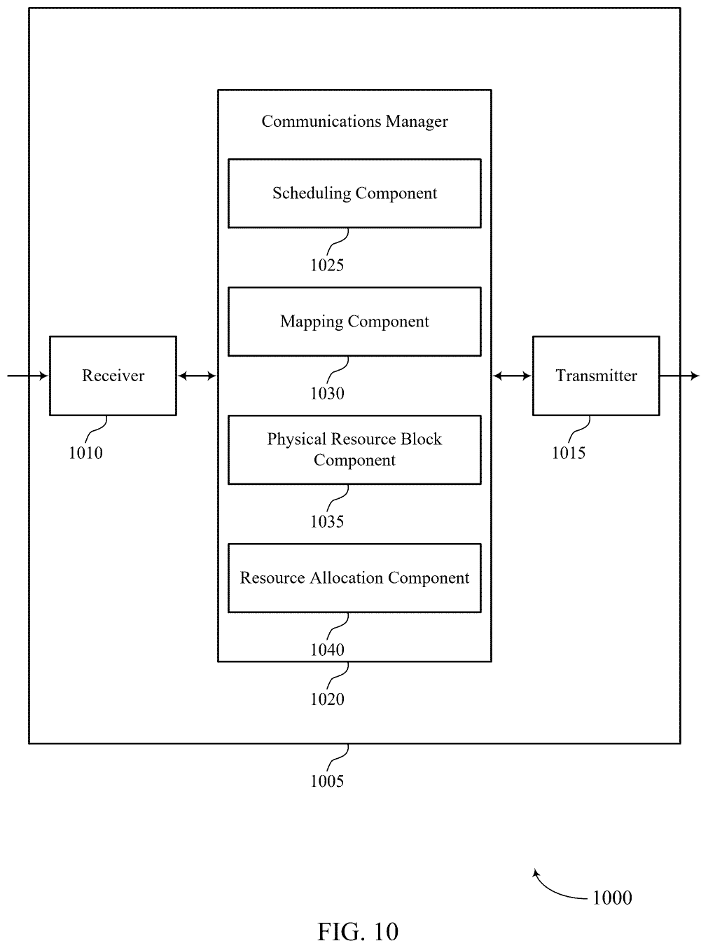

FIG. 10 shows a block diagram 1000 of a device 1005 that supports techniques for partial RB bundling and scaling in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to techniques for partial RB bundling and scaling). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to techniques for partial RB bundling and scaling). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of techniques for partial RB bundling and scaling as described herein. For example, the communications manager 1020 may include a scheduling component 1025, a mapping component 1030, a PRB component 1035, a resource allocation component 1040, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The scheduling component 1025 is capable of, configured to, or operable to support a means for receiving, via a SBFD slot, a control message scheduling a first message associated with a first transmission direction, where the control message includes a non-interleaved RIV indicating a starting virtual RBG and a set of contiguous virtual RBGs. The mapping component 1030 is capable of, configured to, or operable to support a means for mapping the set of contiguous virtual RBGs to a set of physical RBGs based on a determination of whether at least a portion of a first physical RBG is used for communication of the first message, and where the determination is based on the first physical RBG including one or more first PRBs associated with the first transmission direction (e.g., and one or more second PRBs associated with at least one of a second transmission direction or a guard-band). The PRB component 1035 is capable of, configured to, or operable to support a means for communicating the first message based on the set of contiguous virtual RBGs being mapped to the set of physical RBGs.

Additionally, or alternatively, the communications manager 1020 may support wireless communications in accordance with examples as disclosed herein. The scheduling component 1025 is capable of, configured to, or operable to support a means for receiving, via a SBFD slot, a control message scheduling a downlink message, where the control message includes an interleaved RIV indicating a starting VRB bundle and a set of VRB bundles. The mapping component 1030 is capable of, configured to, or operable to support a means for mapping the set of VRB bundles to a set of PRB bundles based on a determination of whether at least a portion of a first PRB bundle is used for communication of the downlink message, where the determination is based on the first PRB bundle including one or more downlink PRBs and one or more uplink PRBs. The PRB component 1035 is capable of, configured to, or operable to support a means for receiving the downlink message based on the set of VRB bundles being mapped to the set of PRB bundles.

Additionally, or alternatively, the communications manager 1020 may support wireless communications in accordance with examples as disclosed herein. The scheduling component 1025 is capable of, configured to, or operable to support a means for receiving, via a SBFD slot, a control message scheduling a first message, where the control message includes a RIV indicating a first starting RB and a set of contiguous RBs. The resource allocation component 1040 is capable of, configured to, or operable to support a means for determining a second starting RB of a resource allocation and a length of the resource allocation based on an integer value, where the integer value is based on a first quantity of RBs of the resource allocation, a size of an active bandwidth part, a predefined value, or any combination thereof. The first quantity of RBs is associated with a first transmission direction. The resource allocation component 1040 is capable of, configured to, or operable to support a means for communicating the first message in accordance with the resource allocation.

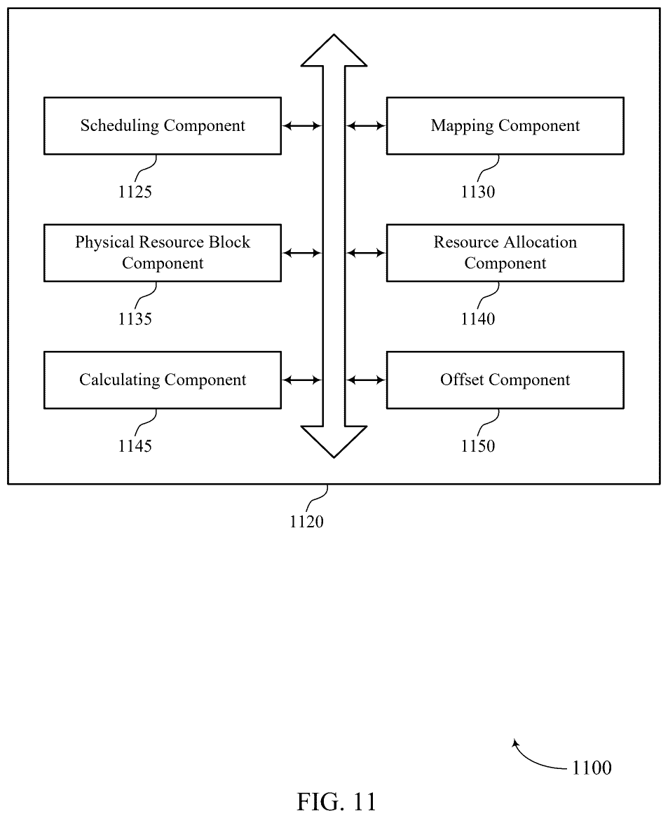

FIG. 11 shows a block diagram 1100 of a communications manager 1120 that supports techniques for partial RB bundling and scaling in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for partial RB bundling and scaling as described herein. For example, the communications manager 1120 may include a scheduling component 1125, a mapping component 1130, a PRB component 1135, a resource allocation component 1140, a calculating component 1145, an offset component 1150, or any combination thereof. Each of these components, or components or subcomponents thereof (e.g., one or more processors, one or more memories), may communicate, directly or indirectly, with one another (e.g., via one or more buses).

The communications manager 1120 may support wireless communications in accordance with examples as disclosed herein. The scheduling component 1125 is capable of, configured to, or operable to support a means for receiving, via a SBFD slot, a control message scheduling a first message associated with a first transmission direction, where the control message includes a non-interleaved RIV indicating a starting virtual RBG and a set of contiguous virtual RBGs. The mapping component 1130 is capable of, configured to, or operable to support a means for mapping the set of contiguous virtual RBGs to a set of physical RBGs based on a determination of whether at least a portion of a first physical RBG is used for communication of the first message, and where the determination is based on the first physical RBG including one or more first PRBs associated with the first transmission direction (e.g., and one or more second PRBs associated with at least one of a second transmission direction or a guard-band). The PRB component 1135 is capable of, configured to, or operable to support a means for communicating the first message based on the set of contiguous virtual RBGs being mapped to the set of physical RBGs.

In some examples, to support determining whether at least the portion of the first physical RBG is used for communication of the first message, the mapping component 1130 is capable of, configured to, or operable to support a means for determining that at least the portion of the first physical RBG is used for communication based at least in part on at least the portion of the first physical RBG including the one or more first PRBs associated with the first transmission direction.

In some examples, the calculating component 1145 is capable of, configured to, or operable to support a means for calculating a transport block size associated with the first message based on a quantity of PRBs, where the quantity of PRBs includes the one or more first PRBs and excludes one or more second PRBs associated with at least one of a second transmission direction or a guard-band.

In some examples, the calculating component 1145 is capable of, configured to, or operable to support a means for calculating a transport block size associated with the first message based on a quantity of PRBs, where the quantity of PRBs includes both the one or more first PRBs and the one or more second PRBs.

In some examples, to support determining whether at least the portion of the first physical RBG is used for communication of the first message, the mapping component 1130 is capable of, configured to, or operable to support a means for determining the first physical RBG is not used for communication based on the first physical RBG including the one or more second PRBs associated with at least one of the second transmission direction or the guard-band.

In some examples, the calculating component 1145 is capable of, configured to, or operable to support a means for calculating a transport block size associated with the first message based on a quantity of PRBs, where the quantity of PRBs excludes both the one or more first PRBs and the one or more second PRBs of the first physical RBG.

In some examples, the SBFD slot includes both a first sub-band and a second sub-band associated with the first transmission direction. In some examples, a size of a last physical RBG of a first subset of the set of physical RBGs is based on a starting RB associated with the SBFD slot, a quantity of RBs associated with the first subset of the set of physical RBGs, a size of each physical RBG of the set of physical RBGs, or any combination thereof. In some examples, the first subset is associated with the first sub-band.

In some examples, the SBFD slot includes both a first sub-band and a second sub-band associated with the first transmission direction. In some examples, a size of a starting physical RBG of a second subset of the set of physical RBGs is based on a size of each physical RBG of the set of physical RBGs, a first RB associated with the second sub-band, or both. In some examples, the second subset is associated with the second sub-band.

In some examples, the control message is associated with a DCI format 1_2 or a DCI format 0_2.

Additionally, or alternatively, the communications manager 1120 may support wireless communications in accordance with examples as disclosed herein. In some examples, the scheduling component 1125 is capable of, configured to, or operable to support a means for receiving, via a SBFD slot, a control message scheduling a downlink message, where the control message includes an interleaved RIV indicating a starting VRB bundle and a set of VRB bundles. In some examples, the mapping component 1130 is capable of, configured to, or operable to support a means for mapping the set of VRB bundles to a set of PRB bundles based on a determination of whether at least a portion of a first PRB bundle is used for communication of the downlink message, where the determination is based on the first PRB bundle including one or more downlink PRBs and one or more uplink PRBs. In some examples, the PRB component 1135 is capable of, configured to, or operable to support a means for receiving the downlink message based on the set of VRB bundles being mapped to the set of PRB bundles.

In some examples, to support determining whether at least the portion of the first PRB bundle is used for communication of the downlink message, the mapping component 1130 is capable of, configured to, or operable to support a means for determining that at least the portion of the first PRB bundle is used for communication based at least in part on at least the portion of the first PRB bundle including the one or more downlink PRBs.

In some examples, the calculating component 1145 is capable of, configured to, or operable to support a means for calculating a transport block size associated with the downlink message based on a quantity of PRBs, where the quantity of PRBs includes the one or more downlink PRBs and excludes the one or more uplink PRBs.

In some examples, the calculating component 1145 is capable of, configured to, or operable to support a means for calculating a transport block size associated with the downlink message based on a quantity of PRBs, where the quantity of PRBs includes both the one or more downlink PRBs and the one or more uplink PRBs.

In some examples, to support determining whether at least the portion of the first PRB bundle is used for communication of the downlink message, the mapping component 1130 is capable of, configured to, or operable to support a means for determining the first PRB bundle is not used for communication based on the first PRB bundle including the one or more uplink PRBs.

In some examples, the calculating component 1145 is capable of, configured to, or operable to support a means for calculating a transport block size associated with the downlink message based on a quantity of PRBs, where the quantity of PRBs excludes both the one or more downlink PRBs and the one or more uplink PRBs of the first PRB bundle.

In some examples, the SBFD slot includes both a first downlink sub-band and a second downlink sub-band associated. In some examples, a size of a last PRB bundle of a first subset of the set of PRB bundles is based on a starting RB associated with the SBFD slot, a quantity of RBs associated with the first subset of the set of PRB bundles, a size of each PRB bundle of the set of PRB bundles, or any combination thereof. In some examples, the first subset is associated with the first downlink sub-band.

In some examples, the SBFD slot includes both a first downlink sub-band and a second downlink sub-band. In some examples, a size of a starting PRB bundle of a second subset of the set of PRB bundles is based on a size of each PRB bundle of the set of PRB bundles available for communication of the downlink message, a first RB associated with the second downlink sub-band, or both. In some examples, the second subset is associated with the second downlink sub-band.

Additionally, or alternatively, the communications manager 1120 may support wireless communications in accordance with examples as disclosed herein. In some examples, the scheduling component 1125 is capable of, configured to, or operable to support a means for receiving, via a SBFD slot, a control message scheduling a first message, where the control message includes a RIV indicating a first starting RB and a set of contiguous RBs. The resource allocation component 1140 is capable of, configured to, or operable to support a means for determining a second starting RB of a resource allocation and a length of the resource allocation based on an integer value, where the integer value is based on a first quantity of RBs of the resource allocation, a size of an active bandwidth part, a predefined value, or any combination thereof. In some examples, the first quantity of RBs is associated with a first transmission direction. In some examples, the resource allocation component 1140 is capable of, configured to, or operable to support a means for communicating the first message in accordance with the resource allocation.

In some examples, the first quantity of RBs associated with the first transmission direction is greater than a second quantity of RBs associated with an initial bandwidth part. In some examples, the integer value is equal to a threshold value of {1, 2, 4, 8} that satisfies the integer value being less than or equal to a floor of the first quantity of RBs associated with the first transmission direction divided by the second quantity of RBs associated with the initial bandwidth part.

In some examples, the first quantity of RBs associated with the first transmission direction is less than or equal to a second quantity of RBs associated with an initial bandwidth part. In some examples, the integer value is equal to 1.

In some examples, both the second starting RB and the length of the resource allocation are within the first quantity of RBs associated with the first transmission direction.

In some examples, the second starting RB is equal to an offset added to the integer value times the first starting RB.

In some examples, the offset component 1150 is capable of, configured to, or operable to support a means for receiving a second control message indicating the offset.

In some examples, the second control message is a radio resource control message or a downlink control information message.

In some examples, the offset component 1150 is capable of, configured to, or operable to support a means for determining the offset based on a first RB in a sub-band, where the sub-band is associated with the first transmission direction.

In some examples, the second starting RB is relative to a first RB in a sub-band. In some examples, the sub-band is associated with the first transmission direction.

In some examples, the predefined value is equal to 1, 2, 3, 4, 5, 6, 7, or 8.

In some examples, the control message is associated with a DCI format 0_0 or a DCI format 1_0.

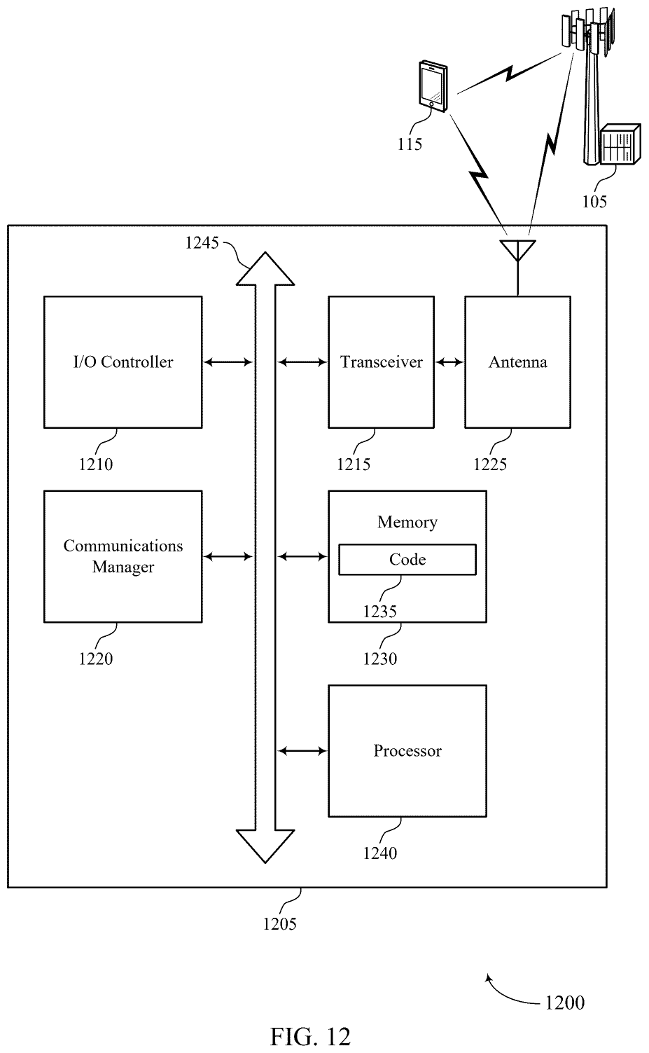

FIG. 12 shows a diagram of a system 1200 including a device 1205 that supports techniques for partial RB bundling and scaling in accordance with one or more aspects of the present disclosure. The device 1205 may be an example of or include components of a device 905, a device 1005, or a UE 115 as described herein. The device 1205 may communicate (e.g., wirelessly) with one or more other devices (e.g., network entities 105, UEs 115, or a combination thereof). The device 1205 may include components for bi-directional voice and data communications including components for transmitting and receiving communications, such as a communications manager 1220, an input/output (I/O) controller, such as an I/O controller 1210, a transceiver 1215, one or more antennas 1225, at least one memory 1230, code 1235, and at least one processor 1240. These components may be in electronic communication or otherwise coupled (e.g., operatively, communicatively, functionally, electronically, electrically) via one or more buses (e.g., a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally, or alternatively, the I/O controller 1210 may represent or interact with a modem, a keyboard, a mouse, a touchscreen, or a similar device. In some cases, the I/O controller 1210 may be implemented as part of one or more processors, such as the at least one processor 1240. In some cases, a user may interact with the device 1205 via the I/O controller 1210 or via hardware components controlled by the I/O controller 1210.

In some cases, the device 1205 may include a single antenna. However, in some other cases, the device 1205 may have more than one antenna, which may be capable of concurrently transmitting or receiving multiple wireless transmissions. The transceiver 1215 may communicate bi-directionally via the one or more antennas 1225 using wired or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The at least one memory 1230 may include random access memory (RAM) and read-only memory (ROM). The at least one memory 1230 may store computer-readable, computer-executable, or processor-executable code, such as the code 1235. The code 1235 may include instructions that, when executed by the at least one processor 1240, cause the device 1205 to perform various functions described herein. The code 1235 may be stored in a non-transitory computer-readable medium such as system memory or another type of memory. In some cases, the code 1235 may not be directly executable by the at least one processor 1240 but may cause a computer (e.g., when compiled and executed) to perform functions described herein. In some cases, the at least one memory 1230 may include, among other things, a basic I/O system (BIOS) which may control basic hardware or software operation such as the interaction with peripheral components or devices.

The at least one processor 1240 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1240 may be configured to operate a memory array using a memory controller. In some other cases, a memory controller may be integrated into the at least one processor 1240. The at least one processor 1240 may be configured to execute computer-readable instructions stored in a memory (e.g., the at least one memory 1230) to cause the device 1205 to perform various functions (e.g., functions or tasks supporting techniques for partial RB bundling and scaling). For example, the device 1205 or a component of the device 1205 may include at least one processor 1240 and at least one memory 1230 coupled with or to the at least one processor 1240, the at least one processor 1240 and the at least one memory 1230 configured to perform various functions described herein.

In some examples, the at least one processor 1240 may include multiple processors and the at least one memory 1230 may include multiple memories. One or more of the multiple processors may be coupled with one or more of the multiple memories, which may, individually or collectively, be configured to perform various functions described herein. In some examples, the at least one processor 1240 may be a component of a processing system, which may refer to a system (such as a series) of machines, circuitry (including, for example, one or both of processor circuitry (which may include the at least one processor 1240) and memory circuitry (which may include the at least one memory 1230)), or components, that receives or obtains inputs and processes the inputs to produce, generate, or obtain a set of outputs. The processing system may be configured to perform one or more of the functions described herein. For example, the at least one processor 1240 or a processing system including the at least one processor 1240 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code 1235 (e.g., processor-executable code) stored in the at least one memory 1230 or otherwise, to perform one or more of the functions described herein.

The communications manager 1220 may support wireless communications in accordance with examples as disclosed herein. For example, the communications manager 1220 is capable of, configured to, or operable to support a means for receiving, via a SBFD slot, a control message scheduling a first message associated with a first transmission direction, where the control message includes a non-interleaved RIV indicating a starting virtual RBG and a set of contiguous virtual RBGs. The communications manager 1220 is capable of, configured to, or operable to support a means for mapping the set of contiguous virtual RBGs to a set of physical RBGs based on a determination of whether at least a portion of a first physical RBG is used for communication of the first message, and where the determination is based on the first physical RBG including one or more first PRBs associated with the first transmission direction (e.g., and one or more second PRBs associated with at least one of a second transmission direction or a guard-band). The communications manager 1220 is capable of, configured to, or operable to support a means for communicating the first message based on the set of contiguous virtual RBGs being mapped to the set of physical RBGs.

Additionally, or alternatively, the communications manager 1220 may support wireless communications in accordance with examples as disclosed herein. For example, the communications manager 1220 is capable of, configured to, or operable to support a means for receiving, via a SBFD slot, a control message scheduling a downlink message, where the control message includes an interleaved RIV indicating a starting VRB bundle and a set of VRB bundles. The communications manager 1220 is capable of, configured to, or operable to support a means for mapping the set of VRB bundles to a set of PRB bundles based on a determination of whether at least a portion of a first PRB bundle is used for communication of the downlink message, where the determination is based on the first PRB bundle including one or more downlink PRBs and one or more uplink PRBs. The communications manager 1220 is capable of, configured to, or operable to support a means for receiving the downlink message based on the set of VRB bundles being mapped to the set of PRB bundles.

Additionally, or alternatively, the communications manager 1220 may support wireless communications in accordance with examples as disclosed herein. For example, the communications manager 1220 is capable of, configured to, or operable to support a means for receiving, via a SBFD slot, a control message scheduling a first message, where the control message includes a RIV indicating a first starting RB and a set of contiguous RBs. The communications manager 1220 is capable of, configured to, or operable to support a means for determining a second starting RB of a resource allocation and a length of the resource allocation based on an integer value, where the integer value is based on a first quantity of RBs of the resource allocation, a size of an active bandwidth part, a predefined value, or any combination thereof. In some examples, the first quantity of RBs is associated with a first transmission direction. The communications manager 1220 is capable of, configured to, or operable to support a means for communicating the first message in accordance with the resource allocation.

By including or configuring the communications manager 1220 in accordance with examples as described herein, the device 1205 may support techniques for partial RB bundling and scaling, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the at least one processor 1240, the at least one memory 1230, the code 1235, or any combination thereof. For example, the code 1235 may include instructions executable by the at least one processor 1240 to cause the device 1205 to perform various aspects of techniques for partial RB bundling and scaling as described herein, or the at least one processor 1240 and the at least one memory 1230 may be otherwise configured to, individually or collectively, perform or support such operations.

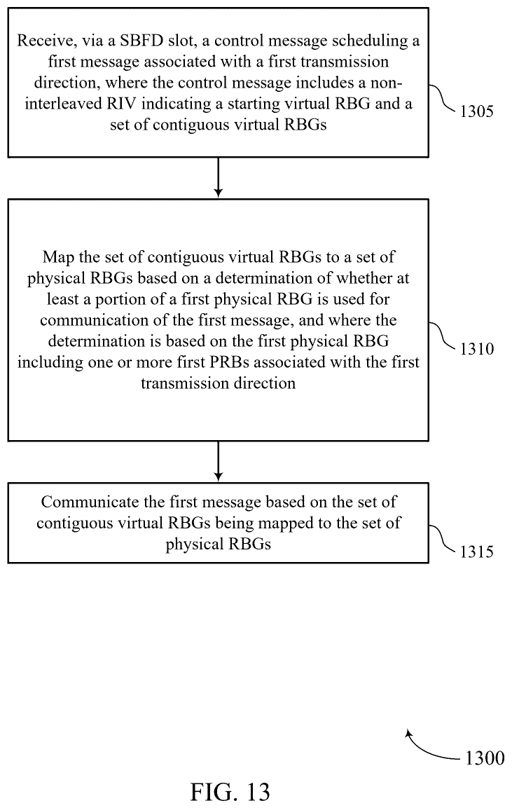

FIG. 13 shows a flowchart illustrating a method 1300 that supports techniques for partial RB bundling and scaling in accordance with one or more aspects of the present disclosure. The operations of the method 1300 may be implemented by a UE or its components as described herein. For example, the operations of the method 1300 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1305, the method may include receiving, via a SBFD slot, a control message scheduling a first message associated with a first transmission direction, where the control message includes a non-interleaved RIV indicating a starting virtual RBG and a set of contiguous virtual RBGs. The operations of 1305 may be performed in accordance with examples as disclosed herein. In some examples, aspects of the operations of 1305 may be performed by a scheduling component 1125 as described with reference to FIG. 11.

At 1310, the method may include mapping the set of contiguous virtual RBGs to a set of physical RBGs based on a determination of whether at least a portion of a first physical RBG is used for communication of the first message, and where the determination is based on the first physical RBG including one or more first PRBs associated with the first transmission direction (e.g., and one or more second PRBs associated with at least one of a second transmission direction or a guard-band). The operations of 1310 may be performed in accordance with examples as disclosed herein. In some examples, aspects of the operations of 1310 may be performed by a mapping component 1130 as described with reference to FIG. 11.

At 1315, the method may include communicating the first message based on the set of contiguous virtual RBGs being mapped to the set of physical RBGs. The operations of 1315 may be performed in accordance with examples as disclosed herein. In some examples, aspects of the operations of 1315 may be performed by a PRB component 1135 as described with reference to FIG. 11.

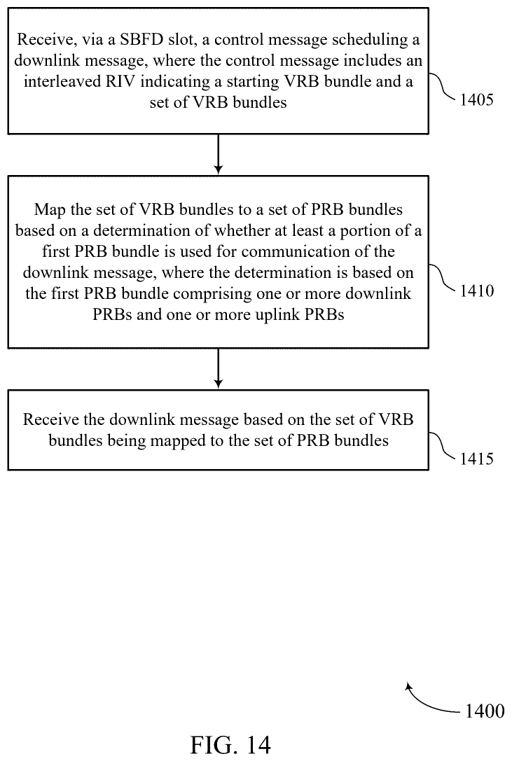

FIG. 14 shows a flowchart illustrating a method 1400 that supports techniques for partial RB bundling and scaling in accordance with one or more aspects of the present disclosure. The operations of the method 1400 may be implemented by a UE or its components as described herein. For example, the operations of the method 1400 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1405, the method may include receiving, via a SBFD slot, a control message scheduling a downlink message, where the control message includes an interleaved RIV indicating a starting VRB bundle and a set of VRB bundles. The operations of 1405 may be performed in accordance with examples as disclosed herein. In some examples, aspects of the operations of 1405 may be performed by a scheduling component 1125 as described with reference to FIG. 11.

At 1410, the method may include mapping the set of VRB bundles to a set of PRB bundles based on a determination of whether at least a portion of a first PRB bundle is used for communication of the downlink message, where the determination is based on the first PRB bundle including one or more downlink PRBs and one or more uplink PRBs. The operations of 1410 may be performed in accordance with examples as disclosed herein. In some examples, aspects of the operations of 1410 may be performed by a mapping component 1130 as described with reference to FIG. 11.

At 1415, the method may include receiving the downlink message based on the set of VRB bundles being mapped to the set of PRB bundles. The operations of 1415 may be performed in accordance with examples as disclosed herein. In some examples, aspects of the operations of 1415 may be performed by a PRB component 1135 as described with reference to FIG. 11.

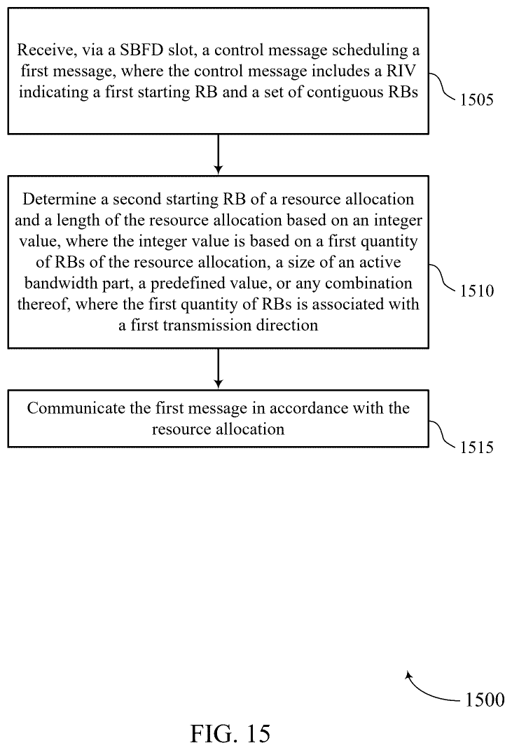

FIG. 15 shows a flowchart illustrating a method 1500 that supports techniques for partial RB bundling and scaling in accordance with one or more aspects of the present disclosure. The operations of the method 1500 may be implemented by a UE or its components as described herein. For example, the operations of the method 1500 may be performed by a UE 115 as described with reference to FIGS. 1 through 12. In some examples, a UE may execute a set of instructions to control the functional elements of the UE to perform the described functions. Additionally, or alternatively, the UE may perform aspects of the described functions using special-purpose hardware.

At 1505, the method may include receiving, via a SBFD slot, a control message scheduling a first message, where the control message includes a RIV indicating a first starting RB and a set of contiguous RBs. The operations of 1505 may be performed in accordance with examples as disclosed herein. In some examples, aspects of the operations of 1505 may be performed by a scheduling component 1125 as described with reference to FIG. 11.

At 1510, the method may include determining a second starting RB of a resource allocation and a length of the resource allocation based on an integer value, where the integer value is based on a first quantity of RBs of the resource allocation, a size of an active bandwidth part, a predefined value, or any combination thereof, where the first quantity of RBs is associated with a first transmission direction. The operations of 1510 may be performed in accordance with examples as disclosed herein. In some examples, aspects of the operations of 1510 may be performed by a resource allocation component 1140 as described with reference to FIG. 11.

At 1515, the method may include communicating the first message in accordance with the resource allocation. The operations of 1515 may be performed in accordance with examples as disclosed herein. In some examples, aspects of the operations of 1515 may be performed by a resource allocation component 1140 as described with reference to FIG. 11.

The following provides an overview of aspects of the present disclosure:

Aspect 1: A method for wireless communications at a UE, comprising: receiving, via a SBFD slot, a control message scheduling a first message associated with a first transmission direction, wherein the control message comprises a non-interleaved RIV indicating a starting virtual RBG and a set of contiguous virtual RBGs; mapping the set of contiguous virtual RBGs to a set of physical RBGs based at least in part on a determination of whether at least a portion of a first physical RBG is used for communication of the first message, and wherein the determination is based at least in part on the first physical RBG comprising one or more first PRBs associated with the first transmission direction and communicating the first message based at least in part on the set of contiguous virtual RBGs being mapped to the set of physical RBGs.

Aspect 2: The method of aspect 1, wherein determining whether at least the portion of the first physical RBG is used for communication of the first message comprises: determining that at least the portion of the first physical RBG is used for communication based at least in part on at least the portion of the first physical RBG comprising the one or more first PRBs associated with the first transmission direction.

Aspect 3: The method of aspect 2, further comprising: calculating a TBS associated with the first message based at least in part on a quantity of PRBs, wherein the quantity of PRBs comprises the one or more first PRBs and excludes one or more second PRBs associated with at least one of a second transmission direction or a guard-band.

Aspect 4: The method of any of aspects 2 through 3, further comprising: calculating a TBS associated with the first message based at least in part on a quantity of PRBs, wherein the quantity of PRBs comprises both the one or more first PRBs and the one or more second PRBs.

Aspect 5: The method of any of aspects 1 through 4, wherein determining whether at least the portion of the first physical RBG is used for communication of the first message comprises: determining the first physical RBG is not used for communication based at least in part on the first physical RBG comprising the one or more second PRBs associated with at least one of the second transmission direction or the guard-band.

Aspect 6: The method of aspect 5, further comprising: calculating a TBS associated with the first message based at least in part on a quantity of PRBs, wherein the quantity of PRBs excludes both the one or more first PRBs the one or more second PRBs of the first physical RBG.

Aspect 7: The method of any of aspects 1 through 6, wherein the SBFD slot comprises both a first sub-band and a second sub-band associated with the first transmission direction, and a size of a last physical RBG of a first subset of the set of physical RBGs is based at least in part on a starting resource block associated with the SBFD slot, a quantity of resource blocks associated with the first subset of the set of physical RBGs, a size of each physical RBG of the set of physical RBGs, or any combination thereof, and the first subset is associated with the first sub-band.

Aspect 8: The method of any of aspects 1 through 7, wherein the SBFD slot comprises both a first sub-band and a second sub-band associated with the first transmission direction, and a size of a starting physical RBG of a second subset of the set of physical RBGs is based at least in part on a size of each physical RBG of the set of physical RBGs, a first resource block associated with the second sub-band, or both, and the second subset is associated with the second sub-band.

Aspect 9: The method of any of aspects 1 through 8, wherein the control message is associated with a DCI format 1_2 or a DCI format 0_2.

Aspect 10: A method for wireless communications at a UE, comprising: receiving, via a SBFD slot, a control message scheduling a downlink message, wherein the control message comprises an interleaved RIV indicating a starting VRB bundle and a set of VRB bundles; mapping the set of VRB bundles to a set of PRB bundles based at least in part on a determination of whether at least a portion of a first PRB bundle is used for communication of the downlink message, wherein the determination is based at least in part on the first PRB bundle comprising one or more downlink PRBs and one or more uplink PRBs; and receiving the downlink message based at least in part on the set of VRB bundles being mapped to the set of PRB bundles.

Aspect 11: The method of aspect 10, wherein determining whether at least the portion of the first PRB bundle is used for communication of the downlink message comprises: determining that at least the portion of the first PRB bundle is used for communication based at least in part on at least the portion of the first PRB bundle comprising the one or more downlink PRBs.

Aspect 12: The method of aspect 11, further comprising: calculating a TBS associated with the downlink message based at least in part on a quantity of PRBs, wherein the quantity of PRBs comprises the one or more downlink PRBs and excludes the one or more uplink PRBs.

Aspect 13: The method of any of aspects 11 through 12, further comprising: calculating a TBS associated with the downlink message based at least in part on a quantity of PRBs, wherein the quantity of PRBs comprises both the one or more downlink PRBs and the one or more uplink PRBs.

Aspect 14: The method of any of aspects 10 through 13, wherein determining whether at least the portion of the first PRB bundle is used for communication of the downlink message comprises: determining the first PRB bundle is not used for communication based at least in part on the first PRB bundle comprising the one or more uplink PRBs.

Aspect 15: The method of aspect 14, further comprising: calculating a TBS associated with the downlink message based at least in part on a quantity of PRBs, wherein the quantity of PRBs excludes both the one or more downlink PRBs the one or more uplink PRBs of the first PRB bundle.

Aspect 16: The method of any of aspects 10 through 15, wherein the SBFD slot comprises both a first downlink sub-band and a second downlink sub-band associated, and a size of a last PRB bundle of a first subset of the set of PRB bundles is based at least in part on a starting resource block associated with the SBFD slot, a quantity of resource blocks associated with the first subset of the set of PRB bundles, a size of each PRB bundle of the set of PRB bundles, or any combination thereof, and the first subset is associated with the first downlink sub-band.

Aspect 17: The method of any of aspects 10 through 16, wherein the SBFD slot comprises both a first downlink sub-band and a second downlink sub-band, and a size of a starting PRB bundle of a second subset of the set of PRB bundles is based at least in part on a size of each PRB bundle of the set of PRB bundles available for communication of the downlink message, a first resource block associated with the second downlink sub-band, or both, and the second subset is associated with the second downlink sub-band.

Aspect 18: A method for wireless communications at a UE, comprising: receiving, via a SBFD slot, a control message scheduling a first message, wherein the control message comprises a RIV indicating a first starting RB and a set of contiguous RBs; determining a second starting RB of a resource allocation and a length of the resource allocation based at least in part on an integer value, wherein the integer value is based at least in part on a first quantity of RBs of the resource allocation, a size of an active BWP, a predefined value, or any combination thereof, wherein the first quantity of RBs is associated with a first transmission direction; and communicating the first message in accordance with the resource allocation.

Aspect 19: The method of aspect 18, wherein the first quantity of RBs associated with the first transmission direction is greater than a second quantity of RBs associated with an initial BWP, and the integer value is equal to a threshold value of {1, 2, 4, 8} that satisfies the integer value being less than or equal to a floor of the first quantity of RBs associated with the first transmission direction divided by the second quantity of RBs associated with the initial BWP.

Aspect 20: The method of any of aspects 18 through 19, wherein the first quantity of RBs associated with the first transmission direction is less than or equal to a second quantity of RBs associated with an initial BWP, and the integer value is equal to 1.

Aspect 21: The method of any of aspects 18 through 20, wherein both the second starting RB and the length of the resource allocation are within the first quantity of RBs associated with the first transmission direction.

Aspect 22: The method of any of aspects 18 through 21, wherein the second starting RB is equal to an offset added to the integer value times the first starting RB.

Aspect 23: The method of aspect 22, further comprising: receiving a second control message indicating the offset.

Aspect 24: The method of aspect 23, wherein the second control message is an RRC message or a DCI message.

Aspect 25: The method of any of aspects 22 through 24, further comprising: determining the offset based at least in part on a first RB in a sub-band, wherein the sub-band is associated with the first transmission direction.

Aspect 26: The method of any of aspects 22 through 25, wherein the second starting RB is relative to a first resource block in a sub-band, and the sub-band is associated with the first transmission direction.

Aspect 27: The method of any of aspects 18 through 26, wherein the predefined value is equal to 1, 2, 3, 4, 5, 6, 7, or 8.

Aspect 28: The method of any of aspects 18 through 27, wherein the control message is associated with a DCI format 0_0 or a DCI format 1_0.

Aspect 29: A UE for wireless communications, comprising one or more memories storing processor-executable code, and one or more processors coupled with the one or more memories and individually or collectively operable to execute the code to cause the UE to perform a method of any of aspects 1 through 9.

Aspect 30: A UE for wireless communications, comprising at least one means for performing a method of any of aspects 1 through 9.

Aspect 31: A non-transitory computer-readable medium storing code for wireless communications, the code comprising instructions executable by one or more processors to perform a method of any of aspects 1 through 9.

Aspect 32: A UE for wireless communications, comprising one or more memories storing processor-executable code, and one or more processors coupled with the one or more memories and individually or collectively operable to execute the code to cause the UE to perform a method of any of aspects 10 through 17.

Aspect 33: A UE for wireless communications, comprising at least one means for performing a method of any of aspects 10 through 17.

Aspect 34: A non-transitory computer-readable medium storing code for wireless communications, the code comprising instructions executable by one or more processors to perform a method of any of aspects 10 through 17.

Aspect 35: A UE for wireless communications, comprising one or more memories storing processor-executable code, and one or more processors coupled with the one or more memories and individually or collectively operable to execute the code to cause the UE to perform a method of any of aspects 18 through 28.

Aspect 36: A UE for wireless communications, comprising at least one means for performing a method of any of aspects 18 through 28.

Aspect 37: A non-transitory computer-readable medium storing code for wireless communications, the code comprising instructions executable by one or more processors to perform a method of any of aspects 18 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, via a sub-band full-duplex (SBFD) slot, a control message scheduling a first message associated with a first transmission direction, wherein the control message comprises a non-interleaved resource indicator value indicating a starting virtual resource block group and a set of contiguous virtual resource block groups;
map the set of contiguous virtual resource block groups to a set of physical resource block groups based at least in part on a determination of whether at least a portion of a first physical resource block group is used for communication of the first message, and wherein the determination is based at least in part on the first physical resource block group comprising one or more first physical resource blocks associated with the first transmission direction; and
communicate the first message based at least in part on the set of contiguous virtual resource block groups being mapped to the set of physical resource block groups.

2. The UE of claim 1, wherein, to determine whether at least the portion of the first physical resource block group is used for communication of the first message, the one or more processors are individually or collectively operable to execute the code to cause the UE to:
determine that at least the portion of the first physical resource block group is used for communication based at least in part on at least the portion of the first physical resource block group comprising the one or more first physical resource blocks associated with the first transmission direction.

3. The UE of claim 2, wherein the one or more processors are individually or collectively further operable to execute the code to cause the UE to:
calculate a transport block size associated with the first message based at least in part on a quantity of physical resource blocks, wherein the quantity of physical resource blocks comprises the one or more first physical resource blocks and excludes one or more second physical resource blocks associated with at least one of a second transmission direction or a guard-band.

4. The UE of claim 1, wherein, to determine whether at least the portion of the first physical resource block group is used for communication of the first message, the one or more processors are individually or collectively operable to execute the code to cause the UE to:
determine the first physical resource block group is not used for communication based at least in part on the first physical resource block group comprising one or more second physical resource blocks associated with at least one of a second transmission direction or a guard-band.

5. The UE of claim 4, wherein the one or more processors are individually or collectively further operable to execute the code to cause the UE to:
calculate a transport block size associated with the first message based at least in part on a quantity of physical resource blocks, wherein the quantity of physical resource blocks excludes both the one or more first physical resource blocks and the one or more second physical resource blocks of the first physical resource block group.

6. The UE of claim 1, wherein the SBFD slot comprises both a first sub-band and a second sub-band associated with the first transmission direction, wherein a size of a last physical resource block group of a first subset of the set of physical resource block groups is based at least in part on a starting resource block associated with the SBFD slot, a quantity of resource blocks associated with the first subset of the set of physical resource block groups, a size of each physical resource block group of the set of physical resource block groups, or any combination thereof, and wherein the first subset is associated with the first sub-band.

7. The UE of claim 1, wherein the SBFD slot comprises both a first sub-band and a second sub-band associated with the first transmission direction, wherein a size of a starting physical resource block group of a second subset of the set of physical resource block groups is based at least in part on a size of each physical resource block group of the set of physical resource block groups, a first resource block associated with the second sub-band, or both, and the second subset is associated with the second sub-band.

8. A user equipment (UE), comprising:
one or more memories storing processor-executable code; and
one or more processors coupled with the one or more memories and individually or collectively operable to execute the code to cause the UE to:
receive, via a sub-band full-duplex (SBFD) slot, a control message scheduling a downlink message, wherein the control message comprises an interleaved resource indicator value indicating a starting virtual resource block bundle and a set of virtual resource block bundles;
map the set of virtual resource block bundles to a set of physical resource block bundles based at least in part on a determination of whether at least a portion of a first physical resource block bundle is used for communication of the downlink message, wherein the determination is based at least in part on the first physical resource block bundle comprising one or more downlink physical resource blocks and one or more uplink physical resource blocks; and
receive the downlink message based at least in part on the set of virtual resource block bundles being mapped to the set of physical resource block bundles.

9. The UE of claim 8, wherein, to determine whether at least the portion of the first physical resource block bundle is used for communication of the downlink message, the one or more processors are individually or collectively operable to execute the code to cause the UE to:
determine that at least the portion of the first physical resource block bundle is used for communication based at least in part on at least the portion of the first physical resource block bundle comprising the one or more downlink physical resource blocks.

10. The UE of claim 9, wherein the one or more processors are individually or collectively further operable to execute the code to cause the UE to:
calculate a transport block size associated with the downlink message based at least in part on a quantity of physical resource blocks, wherein the quantity of physical resource blocks comprises the one or more downlink physical resource blocks and excludes the one or more uplink physical resource blocks, or comprises both the one or more downlink physical resource blocks and the one or more uplink physical resource blocks.

11. The UE of claim 8, wherein, to determine whether at least the portion of the first physical resource block bundle is used for communication of the downlink message, the one or more processors are individually or collectively operable to execute the code to cause the UE to:
determine the first physical resource block bundle is not used for communication based at least in part on the first physical resource block bundle comprising the one or more uplink physical resource blocks.

12. The UE of claim 11, wherein the one or more processors are individually or collectively further operable to execute the code to cause the UE to:
calculate a transport block size associated with the downlink message based at least in part on a quantity of physical resource blocks, wherein the quantity of physical resource blocks excludes both the one or more downlink physical resource blocks and the one or more uplink physical resource blocks of the first physical resource block bundle.

13. The UE of claim 8, wherein the SBFD slot comprises both a first downlink sub-band and a second downlink sub-band associated, wherein a size of a last physical resource block bundle of a first subset of the set of physical resource block bundles is based at least in part on a starting resource block associated with the SBFD slot, a quantity of resource blocks associated with the first subset of the set of physical resource block bundles, a size of each physical resource block bundle of the set of physical resource block bundles, or any combination thereof, and wherein the first subset is associated with the first downlink sub-band.

14. The UE of claim 8, wherein the SBFD slot comprises both a first downlink sub-band and a second downlink sub-band, wherein a size of a starting physical resource block bundle of a second subset of the set of physical resource block bundles is based at least in part on a size of each physical resource block bundle of the set of physical resource block bundles available for communication of the downlink message, a first resource block associated with the second downlink sub-band, or both, and wherein the second subset is associated with the second downlink sub-band.

15. A user equipment (UE), comprising:
one or more memories storing processor-executable code; and
one or more processors coupled with the one or more memories and individually or collectively operable to execute the code to cause the UE to:
receive, via a sub-band full-duplex (SBFD) slot, a control message scheduling a first message, wherein the control message comprises a resource indicator value indicating a first starting resource block and a set of contiguous resource blocks;
determine a second starting resource block of a resource allocation and a length of the resource allocation based at least in part on an integer value, wherein the integer value is based at least in part on a first quantity of resource blocks of the resource allocation, a size of an active bandwidth part, a predefined value, or any combination thereof, wherein the first quantity of resource blocks is associated with a first transmission direction; and
communicate the first message in accordance with the resource allocation.

16. The UE of claim 15, wherein the first quantity of resource blocks associated with the first transmission direction is greater than a second quantity of resource blocks associated with an initial bandwidth part, and wherein the integer value is equal to a threshold value of {1, 2, 4, 8} that satisfies the integer value being less than or equal to a floor of the first quantity of resource blocks associated with the first transmission direction divided by the second quantity of resource blocks associated with the initial bandwidth part.

17. The UE of claim 15, wherein the first quantity of resource blocks associated with the first transmission direction is less than or equal to a second quantity of resource blocks associated with an initial bandwidth part, and wherein the integer value is equal to 1.

18. The UE of claim 15, wherein both the second starting resource block and the length of the resource allocation are within the first quantity of resource blocks associated with the first transmission direction.

19. The UE of claim 15, wherein the second starting resource block is equal to an offset added to the integer value times the first starting resource block.

20. The UE of claim 19, wherein the one or more processors are individually or collectively further operable to execute the code to cause the UE to:
receive a second control message indicating the offset.
